(19) United States
(12) Patent Application Publication
(10) Pub. No.: US 2020/0074339 A1
(43) Pub. Date: Mar. 5, 2020

(54) Fano-Based Information Theoretic Method (FBIT) for Design and Optimization of Nonlinear Systems

(71) Applicants: John A. Malas, Kettering, OH (US); Patricia A. Ryan, Centerville, OH (US); John A. Cortese, Reading, MA (US)

(72) Inventors: John A. Malas, Kettering, OH (US); Patricia A. Ryan, Centerville, OH (US); John A. Cortese, Reading, MA (US)

(73) Assignee: U.S. Government as represented by Secretary of the Air Force, Wright-Patterson AFB, OH (US)

(21) Appl. No.: 16/666,516

(22) Filed: Oct. 29, 2019

Related U.S. Application Data
(63) Continuation-in-part of application No. 14/315,365, filed on Jun. 26, 2014, now abandoned.
(60) Provisional application No. 61/914,429, filed on Dec. 11, 2013.

(51) Int. Cl. G06N 7/08; G06N 7/00; G06N 7/02

(52) U.S. Cl. CPC G06N 7/08; G06N 7/02; G06N 7/005

(57) ABSTRACT

The present disclosure includes theoretical models and methods for identifying and quantifying information loss in a system due to uncertainty and analyzing the impact on the reliability of system performance. These models and methods join Fano's equality with the Data Processing Inequality in a Markovian channel construct in order to characterize information flow within a multi-component nonlinear system and allow the determination of risk and characterization of system performance upper bounds based on the information loss attributed to each component. The present disclosure additionally includes methods for estimating the sampling requirements and for relating sampling uncertainty to sensing uncertainty. The present disclosure further includes methods for determining the optimal design of components of a nonlinear system in order to minimize information loss, while maximizing information flow and mutual information.

### CROSS-REFERENCE TO RELATED APPLICATIONS

The present application is a continuation-in-part of U.S. patent application Ser. No. 14/315,365, entitled “Fano-Based Information Theoretic Method (FBIT) for Design and Optimization of Nonlinear Systems”, [Docket AFD-1296] filed 26 June 2014, which in turn claims the benefit of priority under 35 U.S.C. § 119(e) to U.S. Provisional Application Ser. No. 61/914,429 entitled “TITLE,” [Docket AFD-1296P] filed 11 December 2013, the contents of all of which are incorporated herein by reference in their entirety.

### ORIGIN OF THE INVENTION

The invention described herein was made by employees of the United States Government and may be manufactured and used by or for the Government of the United States of America for governmental purposes without the payment of any royalties thereon or therefore.

### BACKGROUND

### 1. Technical Field

This invention relates generally to the field of information theory. More particularly, it relates to an information theory method that uses the Fano equality with the Data Processing Inequality in a Markovian channel construct for the study of component-level uncertainty and information loss within a system.

### 2. Description of the Related Art

Recent innovations in radio frequency (RF) sensing component technology, particularly in the area of remote target signature measurement and exploitation, include multi-channel spatially diverse antennas, sensitive receivers, fast analog-to-digital converters, adaptive transmit waveforms, and sparse sampling approaches. These innovations support new signature information sensing functions such as calibrated target measurements, feature processing, and inference-based decision algorithms. The ability to characterize target information extraction while under the effects of system uncertainties is critical to the full application of the scientific method in the expanding trade space of the new functional capabilities, particularly regarding waveform design and the analysis of radar signatures and radar systems. Regardless of the application, the success of any information systems theory model will largely depend on its ability to address several challenges: the ability to (1) characterize the performance of modular systems within critical regions in the space of inputs while under the effects of various sources of uncertainty; (2) propagate the effects of these uncertainly sources acting on individual components within the system to the predicted system performance measures; (3) effectively minimize the overall loss in the information flow while trading costs associated with component design, and (4) operate effectively within the nonlinear high dimensional spaces inherent in many systems such as signature sensor systems.

A variety of information theoretic approaches have been formulated and applied to the area of RF sensing, particularly to the analysis and design of waveforms and radar systems such as new radar architecture referred to as the MIMO (Multiple Input Multiple Output) radar. For example, information theory-based frameworks employing a variety of techniques have been presented in the field of radar analysis, including application of the Fano bound to train and develop target classifiers in automatic target recognition (ATR) systems and use of mutual information (MI) as a similarity measure for the evaluation of suitability of radar signature training surrogates. Other approaches, such as the information bottleneck approach, have presented the radar system in terms of a Markov Chain within a channel configuration and characterized the information flow from source to sink in order to, for example, study information loss. However, existing systems theory prototypes frequently fall short in their ability to fully characterize the flow of information through the components of a sensing system while that system is subjected to the effects of system uncertainty. The ability to isolate the effects of uncertainty within the components of the system allows for component design trade methods that lead to optimal information flow.

In engineering scenarios, the error associated with system parameters is of interest. For example, the tolerance of machined components in a mechanical system are a key consideration in the manufacturing process, impacting the amount of testing and measurement needed to ensure compliance, as well as a contributing factor to overall system assembly expense (generally, the more stringent the fabrication requirements, the more expensive the end product.) Similarly, the confidence a user has in a meter reading value output by a system is also of critical importance. For example, a pilot needs to know whether the fuel gauge in an airplane cockpit indicates that the aircraft can reach its destination with 50%, 90% or 100% confidence.

The uncertainty associated with a system parameter is typically due to many sources. In traditional linear signal processing models with additive Gaussian noise, sources of uncertainty (noise) are assumed to be statistically independent. Because the sum of Gaussians is a Gaussian, the final overall uncertainty for a system output value is easily tabulated from the individual component uncertainties. Real life systems however often have nonlinear behavior. In addition, the noise may not be Gaussian, additive, or statistically independent. These deviations from the linear, additive independent Gaussian noise model quickly make uncertainty and error estimation analytically intractable. As a recourse, engineers frequently resort to numerical simulation methods such as Monte Carlo-based techniques. However, real life systems have a large number of degrees of freedom and numerical simulation in such situations must be carefully addressed. Hence, the need arises for accurate, analytically-based, methods for uncertainty estimation and propagation analysis.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 is an exemplary depiction of an exemplary decision rule subspace.

FIG. 2 is an exemplary depiction of an exemplary Markovian channel model.

FIG. 3A is a flowchart illustrating an exemplary method according to the present disclosure for characterizing information flow and loss in a nonlinear system comprising two or more components that are subject to one or more sources of uncertainty.

FIG. 3B is a flowchart illustrating an exemplary method according to the present disclosure for determining optimal component design for a nonlinear system comprising two or more components that are subject to one or more sources of uncertainty.

FIG. 4 is a plot illustrating the relationship of Pₑ to F(x).

FIG. 5 is an exemplary plot illustrating possible tradeoffs between information vs. component design.

FIG. 6 is a flowchart illustrating a modeling and analysis approach to uncertainty propagation within the sensitivity analysis and modeling of an information sensing system.

FIG. 7 is a plot illustrating the inverse entropy function.

FIG. 8 is a plot of the slope at an example operating point identified in FIG. 7.

FIG. 9 is a plot illustrating the phase transitions in \vec{X} and computing the minimum sampling N_{M} using the Maximum Likelihood Estimate (MLE) method.

FIG. 10 is an isometric view of a three-dimensional depiction of a target cluster in a radar sensor coordinate system.

FIG. 11 is an exemplary depiction of propagating uncertainty in a system.

FIGS. 12A and 12B are plots illustrating the amplitude response for the N sample ensemble of high range resolution radar signatures for a baseline set of conditions defined as Case 2 (μᵣ=0 and μₜ=0).

FIG. 13 is a plot illustrating the phase transition within a typical set of \vec{X} vs. N, where n_{b}=6.

FIG. 14 is a plot illustrating the scaled standard deviation of estimator of entropy of \vec{X} vs. N, where n_{b}=6 and L=1000.

FIG. 15 is a plot illustrating the scaling properties of Î(H; \vec{X}), Î(H; \vec{Y}) , and Î(H; Q) vs. ensemble size N, where N_{T}=3×10³, n_{b}=6, and L=1000.

FIG. 16 is a plot comparing the calculated probability of error estimate to the probability of error computed using simulation.

FIG. 17 is a plot illustrating the application of Eq. (44) to the results of FIG. 15.

FIG. 18 is a plot illustrating application of Eq. (48) to the radar example at the three link positions \vec{X}, \vec{Y} and Q.

FIG. 19 is a plot comparing the performance given by the Fano approximation using Case 2 (μᵣ=0 and μₜ=0) conditions, the simulated “true” performance, and the performance using the equality form of Fano in Theorem I.

FIG. 20 is a plot illustrating an exemplary system trade between mutual information and thermal noise.

FIG. 21 is a plot illustrating an exemplary system trade between mutual information and dynamic range.

FIG. 22 is a plot illustrating an exemplary system trade between mutual information and bandwidth.

FIG. 23 is a plot illustrating the individual contributions to the cumulative link loss variance in an incremental fashion.

FIG. 24 is a plot illustrating the relationships between the channel mutual information, the predicted link performance, and the reliability of the predicted link performance.

FIG. 25 is a plot illustrating the reliability of the predicted link performance as a variance.

### DETAILED DESCRIPTION

The present disclosure includes a method for identifying and characterizing component-level information loss in a nonlinear system comprising a plurality of components, one or more of which are subject to at least one source of uncertainty that each comprises a plurality of system uncertainty parameters. The method comprises the steps of: a) determining discrete decision states for the nonlinear system that comprise a true object state H and a decision state Q, with the discrete decision states being characterized in a Markovian channel model comprising a plurality of links that each correspond to one component of the nonlinear system; b) modeling the system uncertainty parameters to create a plurality of distributions that each comprise a plurality of values ranging from a theoretical maximum entropy to a theoretical minimum entropy for one system uncertainty parameter, in which at least one of the system uncertainty parameters is unknown; c) calculating an entropy at each component, H(H), H(X), H(Y), . . . H(Q), that is directly related to an amount of uncertainty at each component; d) computing an amount of mutual information between H and Q, I(H;Q), in which I(H;Q) is used to characterize a total system performance and the one or more sources of uncertainty increases a total amount of entropy in the nonlinear system, thereby decreasing I(H;Q) and degrading the total system performance; e) calculating an amount of cumulative component information loss from H to Q, IL_{X}, IL_{Y}, . . . IL_{Q}, in which IL_{Q} is equal to a sum of the component-level information loss that occurs at each component, IL_{XΔ}, IL_{YΔ}, . . . IL_{QΔ}, and component-level information loss occurs only within the Markovian channel model; f) correlating, using Fano's equality, at least one of I(H;Q) and IL_{Q} to the total amount of entropy to generate at least one overall probability of error, Pₑ, for the nonlinear system; g) estimating, using the Data Processing Inequality together with Fano's equality, a component-level probability of error, Pₑ^{X}, Pₑ^{Y}, . . . Pₑ^{Q}; and h) correlating the component-level probability of error to the component-level information loss.

The present disclosure further includes a method for computing a component-level performance reliability and attributing a contribution of each system uncertainty parameter to the component-level performance reliability by: a) determining a real world statistical variation of the system uncertainty parameters; b) performing a Monte-Carlo simulation of a plurality of the statistical uncertainty parameters for a plurality of settings by iteratively performing, according to the present disclosure, the step of modeling the system uncertainty parameters through the step of correlating the component-level probability of error to the component-level information loss; c) calculating a component-level probability of error statistical distribution at each component; d) determining the component-level performance reliability based on a standard deviation of each component-level probability of error statistical distribution; and e) correlating the contribution of each system uncertainty parameter to the component-level performance reliability. In some embodiments, the step of performing the Monte-Carlo simulation further comprises determining a proper ensemble sample size.

The present disclosure further includes a method for determining at least one component-level ensemble sampling requirement comprising the steps of: a) determining a set of test criteria for a maximum allowable sampling uncertainty of the component-level information loss relative to the component-level probability of error statistical distributions; b) determining a sample ensemble size N_{M} for the component-level information loss using a phase transition method; and c) computing the component-level performance reliability using a numerical simulation method on the sample ensemble size N_{M}. In some embodiments, the numerical simulation method comprises Monte Carlo modeling.

The present disclosure further includes a method for determining an optimal component design for a nonlinear system comprising a plurality of components, one or more of which are subject to at least one source of uncertainty that each comprises a plurality of system uncertainty parameters. The method comprises the steps of: a) establishing an information loss budget comprising a desired Pₑ^{Q}; b) calculating, according to the present disclosure, the component-level information loss, IL_{XΔ}, IL_{YΔ}, . . . IL_{QΔ}; c) calculating, according to the present disclosure, component probability of error, Pₑ^{X}, Pₑ^{Y}, . . . Pₑ^{Q}, to generate a calculated Pₑ^{Q}; d) comparing the calculated Pₑ^{Q} with the desired Pₑ^{Q}; e) identifying at least one source of information reduction that comprises component-level information loss and/or information flow reduction; f) determining the optimal component design to minimize the calculated Pₑ^{Q} that includes at least one tradeoff between information flow and component design, in which the tradeoff decreases the at least one source of information reduction; and g) repeating the step of calculating component-level information loss through the step of determining the optimal component design until the calculated Pₑ^{Q} is equal to or less than the desired Pₑ^{Q}. In some embodiments, the method further comprises identifying at least two sources of information reduction that comprise component-level information loss and/or information flow reduction, ranking the two or more sources of information reduction according to impact on the calculated Pₑ^{Q} to identify at least one dominant source of information reduction, and determining the optimal component design to minimize the calculated Pₑ^{Q}, in which the optimal component design includes at least one tradeoff between information flow and component design that reduces the at least one dominant information loss source.

The present disclosure includes theoretical models and methods for identifying and quantifying information loss in a system due to uncertainty and analyzing the impact on the reliability of (or confidence in) system performance. These models and methods join Fano's equality, which is derived from Fano's inequality, with the Data Processing Inequality in a Markovian channel construct. In particular, the presently disclosed invention allows for the study of information flow and the effects of uncertainty on the information flow within the various components of a system. The present disclosure allows the determination of risk and characterization of system performance upper bounds based on the information loss attributed to each component. Taking an information theoretic view, degrading effects are considered as sources of entropy, which may be used to represent propagating uncertainty within an information channel. Treating the system as an information flow pipeline from input to output, the propagating effects of various sources of uncertainty (i.e. entropy) degrade the mutual information (MI) between the input and output. Development and application of a systems theory model allows for performing component-level design trades within the information sensing application based on a component-level information loss budget (Bits). Demonstration of the max flow in conjunction with the Data Processing Inequality further identifies information flow bottlenecks and provides analysis of these bottlenecks in the information flow pipeline.

The presently disclosed models and methods may be particularly useful within radar signature exploitation systems, and as such, key attributes of the presently disclosed theoretical models and methods are demonstrated under the constraints of a radar high range resolution (HRR) sensor system example. Simplified target scattering models are used to illustrate the value of component-level analysis under the effects of various sources of uncertainty in sensing systems. While the present disclosure is often referenced throughout with relation to radar and radar systems, one of ordinary skill in the art will appreciate that these models and methods may be employed in the design and analysis of a wide variety of systems and structures, including production/assembly lines, communications systems, and virtually any other multi-component system containing sources of uncertainty.

The use of information theoretic principles in the presently disclosed models and methods affords several advantages in dealing with the challenges associated with a variety of systems, particularly those in the areas of information sensing and exploitation. First, information theory prototypes enable the study of the propagating effects of various sources of uncertainty on system performance at the point of noise infiltration. For example, using Fano's inequality, the max flow criteria bounds the optimal Bayes error. Entropy and MI are analytically connected to the probability of error (Pₑ), and more generally the Neyman Pₑ arson criteria, allowing for the rate of noise infiltration to be related to the rate of entropy growth and ultimately to the rate of degradation of system performance. The information loss associated with uncertainty sources can then be characterized in terms of a confidence interval about the predicted system performance at each component of the system. The Data Processing Inequality affords a method to determine information loss points and maximize information flow via component trades within a system information loss budget.

Second, the convexity of MI yields a unique solution and enables rapid numerical convergence (low computational complexity) to maximum MI configurations. MI affords the optimization of a scalar quantity, while classical Bayes likelihood ratio techniques involve optimizing on non-convex surfaces over high dimensional signature spaces. On a convex surface, the use of highly efficient search algorithms such as the Conjugate Gradient method will converge on the order of N operations (N dimensional problem). While entropy-based methods operate non-parametrically such that the probability does not have to be estimated, complicating factors can include numerical computation issues that occur within high dimensional processes (Bellman's Curse of Dimensionality). It can be shown, however, that computing the entropy of the multivariate sensor signature processes is also O(N). As a consequence of the law of large numbers, the asymptotic equipartition property asserts that there are large regions within the entropic signature subspace that will never occur under the decision hypotheses. Thus, the information theoretic approach holds the potential to exploit entropy-based methods operating within this “typical” signature subspace.

Third, classical statistical pattern recognition approaches use the maximum likelihood (ML) decision criteria, which include only the second order statistics present in the training process. The use of MI in nonlinear processing affords advantages over linear processing in that it accounts for higher-order statistics within the design of nonlinear optimal decision rules and in the optimization of features. In the context of radar systems, nonlinear scattering phenomenon resulting from the interaction of individual target mechanisms can also reduce the effectiveness of second order techniques in the optimization of diverse transmit waveforms. The use of MI as a nonlinear signal processing method for optimizing waveform design will address this phenomenon. It is these inherent benefits that distinguish the presently disclosed information theoretic models and methods over traditional statistical pattern recognition methods.

The present disclosure additionally includes methods for estimating the sampling requirements for entropic quantities based, for example, on a characterization of the typical set underlying the sufficient statistics of a random signature process. Interdependencies among multivariate target signatures can significantly impede information extraction, and the expansion of the signature statistical support is related to incremental increases in uncertainty. Baseline statistical support (in the native coordinate system) associated with the resolved radio frequency target scattering is characterized for specified states of certainty. The performance estimate variance associated with lower sample counts within a Monte Carlo experiment may be scaled (via central limit theorem) to the estimate variance associated with higher sample counts.

The present disclosure further includes methods for relating sampling uncertainty to sensing uncertainty to better understand the entropic effects within the information sensing system and to ensure confidence estimates are of sufficiently low variance. Referring to radar signature analysis, both sensor uncertainty and model training uncertainty are propagated into a classifier algorithm where uncertain decisions are inferred from uncertain observations. The uncertainty (i.e. the increase in entropy) is ultimately realized in the form of confidence or reliability intervals about the estimated system performance. A sensitivity analysis is performed to study the relative significance of various “unknown” operating conditions to the reliability of the performance estimate at each component of the system. The effects of sampling uncertainty are contrasted to reliability of performance estimates in order to study the variance effects in performance estimation within high dimensional signature processes subject to unknown operating conditions.

Uncertainty Analysis: In the sensor measurement community, “accuracy” generally refers to the agreement between a measured value and the true or correct value, while “precision” generally refers to the repeatability of a measurement. “Error” refers to the disagreement between the measured value and the true or accepted value. The “uncertainty” in a stated measurement is the interval of confidence around the measured value such that the measured value is expected not to lie outside this stated interval. This use of the term “uncertainty” implies that the true or correct value may not be known and can be stated along with a probability, which recognizes the deterministic nature of error and the stochastic nature of uncertainty. However, this definition is often insufficient to address the full range of issues within an information sensing system containing multiple sources of uncertainty.

For example, radar systems produce signature measurements that when combined with the effects of various system uncertainties, are realized as a random signature process. Conclusions are inferred by applying instances taken from this random measured signature process to a decision rule. The “unknowable” nature of parameters affecting the measured signature process leads to challenges in developing a signature process model that will generate the optimal decision rule for inferring information. The combined effects of these uncertainties limit the exploitation of physics-based features and result in a loss in information that can be extracted from target signature measurements. The resulting decision uncertainty is driven by both the distorted measurements and the degree of agreement between the signature process under measurement and the process used to train the optimal decision rule.

As a specific example, measurement of airborne moving objects using high range resolution (HRR) waveforms is complicated by several sources of uncertainty. As shown in Table 1, two classes of system uncertainty are introduced into the system: sensing uncertainty and uncertainty resulting from decision rule training limitations. Sensing uncertainty is further divided into three subcategories: (a) signature measurement uncertainty due to sensor design/limitations; (b) object tracking position and motion uncertainty; and (c) uncertainty due to interference.

The object under measurement by the sensing radar system can be viewed as a collection of scattered field sources filling an electrically large volume in space. The system measurement of this object is subject to uncertainty identified in source 1(a) generating the statistical support underlying a random signature process at a fixed position in time. Target fixed body motion within the measurement interval induces scintillation within the scattering sources, resulting in an additional increase in entropy. Imperfect knowledge of target position, velocity, and aspect also alters the statistical characterization of the random signature process (source 1(c)), and the random signature process interacts with an external environment (source 1(b)) to further impact the statistical nature of the measured signature process.

TABLE 1
RADAR SYSTEM UNCERTAINTY SOURCES

| Uncertainty Core Area | Parameter Uncertainty Subcategory | | |
|---|---|---|---|
| 1. Sensing | | | |
| (a) Signature | Nonlinear | I&Q Quantization/ | Amplitude & |
| Measurement | Effects | Clipping | Phase Calibration |
| (b) Environmental | Clutter/ | RF Interference | Jamming |
| | Thermal Noise | | |
| (c) Object Tracking & | Object Range, | Object Articulation | Intra-measurement |
| Motion | Velocity, & | | Motion |
| | Aspect | | |
| | Estimates | | |
| 2. Decision Rule Training | Process Under | Target Configuration | Target Modeling |
| Limitations | Sampling | Variation | Parameters |

These sources of uncertainty, along with limitations within the training process, result in a decision rule design that is less than optimal with respect to system performance. The exploitation of this signature process using a decision algorithm requires the training (generally via supervised learning) of an optimal decision rule that operates within the entropy produced by sources 1(a)-(c), but only a subset of the phenomenon (parameters) underlying source 1 can be modeled and/or characterized within the statistical decision rule training process. While uncertainty source 1(a) is generally epistemic and may be modeled and characterized, uncertainty sources 1(b), 1(c), and 2 are aleatoric in nature and are generally considered “unknowable.” As such, uncertainty sources 1(b), 1(c), and 2 may generally only be characterized statistically and may result in a reduction in certainty from the highest certainty state.

The sources of uncertainty associated with source 2 in Table 1 are traceable to the corresponding effect within the decision rule subspace in the classical statistical pattern recognition approach to the binary hypothesis testing. The decision rule design (threshold d) is based on statistical training support resulting from the uncertainties in Table 1. If the sensing uncertainties within source 1 are adequately represented in the statistics of the training process, the decision rule design should provide optimal performance; however, the effects due to many of the uncertainties in Table 1 are unavoidable. For example, realizations are often formed through the integration of many sequential measurements. Intra-measurement object motion can cause distortion and induce uncertainty in the decision rule subspace that is not accounted for in the decision rule training process. In another example, the object under measurement may be configured differently than that represented in the training data (extra fuel tanks, wing flaps up, or damaged surface for example).

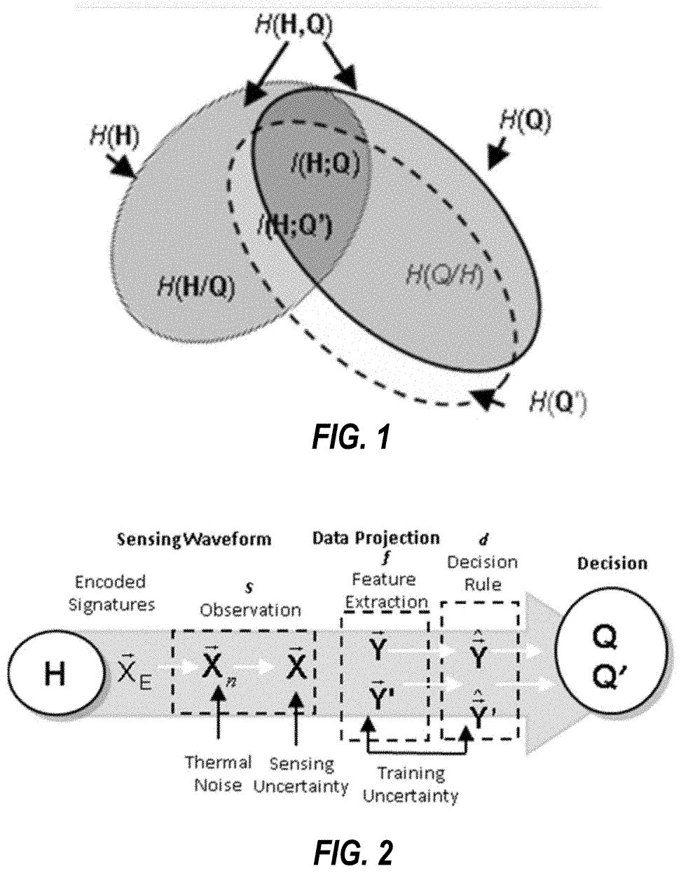

Information Theoretic Decision Rule Subspace: Referring now to the drawings, like reference numerals may designate like or corresponding parts throughout the several views. One approach to viewing the decision rule subspace is shown in FIG. 1, where the decision rule subspace is cast in terms of information theoretic quantities based on entropy, which is a measure of the size of a typical set. In FIG. 1, information is defined in terms of the MI, I(H;Q), I(H;Q′), between the “typical subspaces” associated with the true object state H and the decision state Q, where H and Q are discrete random variables and Q is of the same alphabet as H. FIG. 1 also includes an additional subspace H(Q′), which represents an altered Q based on a non-optimal decision rule (discussed in more detail herein). Systems (and associated sub-component) designs that increase the MI between these “typical signature subspaces” increase the flow of information, while the introduction of sources of uncertainty acts to alter to the typical signature subspaces (growth or movement) associated with the highest certainty state. A change to the typical subspaces can result in a loss in the flow of information and a decrease in decision performance, creating overlapping subspaces that reflect a decreased amount of MI.

Information Theoretic Radar Channel Model: The concept of uncertainty introduced in FIG. 1 may be realized in terms of an increase in entropy within a Markov chain, which is a discreet memoryless information channel referred to herein as a Markovian channel. Information sensing systems such as a radar information sensing system may be viewed within this Markovian channel model, which is depicted in FIG. 2 as the information flow through the signature sensing and processing components of a radar system. In FIG. 2, the relationship between H and Q is the basis chosen for performance characterization. The discrete random variable H represents which of the N_{c} possible hypotheses has occurred. Successful flow of information results in agreement between H and Q.

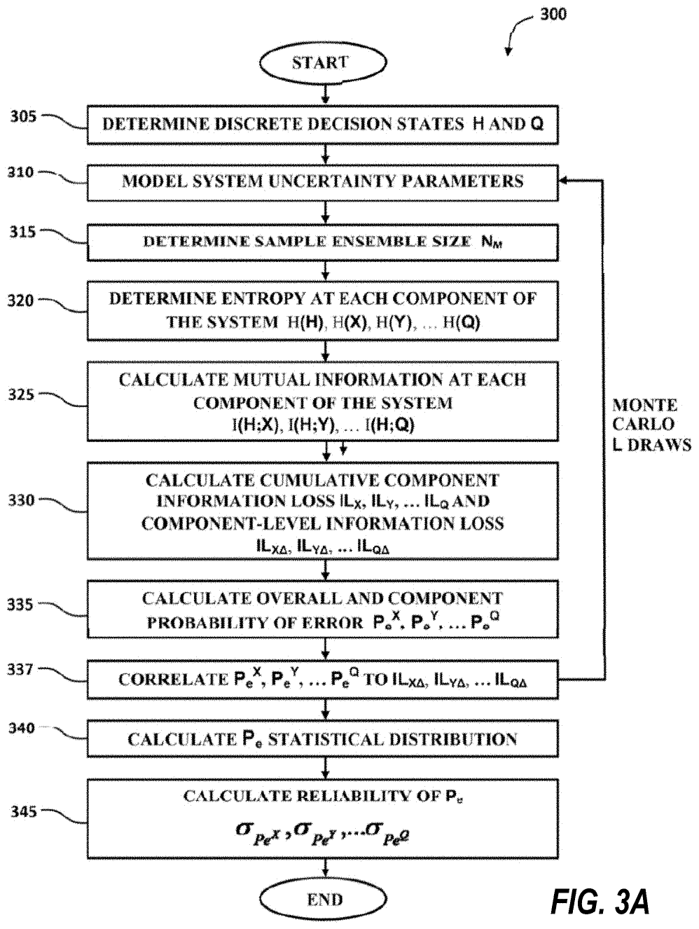

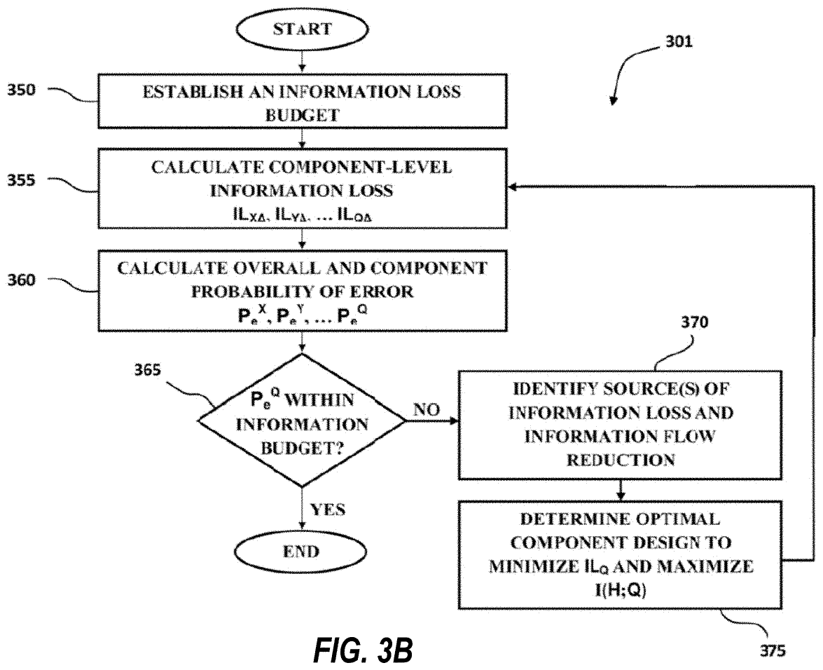

Referring to FIGS. 2 and 3, exemplary models and methods according to the present disclosure will be described. FIG. 3A is a flowchart illustrating an exemplary method 300 for identifying, characterizing, and quantifying information loss in a nonlinear system that comprises two or more components or links that experience information loss due to one or more sources of uncertainty. The method 300 begins with determining discrete decision states i.e. input and output states for the nonlinear system (Step 305). These discrete decision states may comprise a true object state (input) H and a decision state (output) Q, where H and Q are of the same alphabet and are characterized in a Markovian channel model, where the model comprises a plurality of links that each correspond to one component of the nonlinear system.

One or more of the components of the system comprising links or stages within the Markovian channel model, referred to here as X, Y, . . . , is subject to at least one source of uncertainty. In Step 310, these sources of uncertainty, each of which may comprise a variety of governing system uncertainty parameters or variables, are modeled. Modeling the parameters creates a series of distributions, each of which represents a set of values ranging from the theoretical maximum value of entropy to the theoretical minimum value for each parameter. For example, in a radar system, these variables may include values that are constantly changing and/or that are unknowable or aleatoric such as the target aspect angle, the leading edge location, thermal noise, the presence of jamming frequencies, etc. These aleatoric variables must generally be characterized statistically, and these characterizations may be in the form of statistical distributions or in the case of radar systems, range bins.

Continuing with the radar system example, X in FIG. 2 is generally a multidimensional probability distribution of radar returns, which become multidimensional probability distribution Y following signal processing, and Q denotes the classifier algorithm decision of which hypothesis H (instance of H) occurred based on Y. Conditioned on the generating hypothesis H (instance of H), there is typically a multidimensional encoded source \vec{X}_{E}, which is realized as the image projection of the scattered field of the object under measurement i.e. a target. In this context, \vec{X}_{E} is deterministic, resulting from the convolution of the target's physical scattering mechanisms with the transmitted waveform s, and given the “unknowable” nature of this code through measurement or modeling, the code itself is only observable in the random form of \vec{X}. In the case of HRR radar measurements, \vec{X}_{E} is the band-limited frequency response associated with the scattered field of the observed object in thermal noise. As shown for example in FIG. 2, after mixing, filtering, and signal processing, these returns become the measured random signature vector \vec{X}ₙ. The sensing of \vec{X}ₙ is subjected to the uncertainties listed in source 1 of Table 1, leading to the random signature process \vec{X}. The various cases of the sensed signature are summarized in Table 2.

TABLE 2
SENSOR MEASUREMENT SIGNALCASES

| | |
|---|---|
| Encoded Deterministic Multivariate | \vec{X}_{E} |
| Signal | |
| Deterministic Signal in Additive | \vec{X}ₙ = \vec{X}_{E} + \vec{n} |
| Noise | |
| Random Multivariate Signal in | \vec{X} = \vec{X}_{E} + \vec{n} |
| Additive Noise | |

The multivariate sample feature \vec{Y}ⁱ is extracted from the i^{th} instance test sample \vec{X}ⁱ to support the desired function of the exploitation system. Given the random nature of \vec{X}, the extracted signature feature \vec{Y} is also random. The training feature process \vec{Y}′ is developed from the set of typical signatures within a decision rule training process \vec{X}′ (not separately shown). \vec{X}′ (and thus \vec{Y}′) is developed offline using a surrogate process and is used to determine the ‘optimal’ decision rule d. The decision algorithm applies \vec{Y}ⁱ to the decision rule d, yielding the decision Q (instance of Q) declaring which of the hypotheses has occurred.

Referring still to FIG. 3A, the method 300 continues with determining a sample ensemble size N_{M} (Step 315) as described in more detail herein. For example, N_{M} may be determined using a phase transition method (also described in more detail herein). In the radar system example, the evaluation of an ensemble N_{M} of test samples \vec{X}ⁱ {i=1→N_{M}} produces the sample ensemble of the N_{M} matching tests (H,Q) to statistically characterize the decision performance.

Following determination of the sample ensemble size N_{M} (Step 315), the next step is calculating an amount of entropy at each component of the system (Step 320). An instance of each parameter is drawn from the distributions created in Step 310, and based on the N_{M} ensemble of samples calculated in Step 315, the entropy is determined for each component of the system H(H), H(X), H(Y), . . . H(Q). The amount of entropy at each component of the system is equal to H(H), H(X), H(Y), . . . H(Q), respectively, and a total amount of entropy for the system is equal to the sum of the entropies at each component. The next step is computing the amount of MI between H and all other components, including the output of the system at Q, I(H ;X), I(H ;Y), . . . I(H;Q) (Step 325). The one or more sources of uncertainty may cause a degradation of performance by increasing the amount of entropy in the nonlinear system and thus decreasing I(H;Q). I(H;Q) may be mathematically related to the total system performance as described herein, thereby allowing a correlation between increases in entropy, decreases in MI, and changes in system performance.

Following calculation of MI in Step 325, the next step is determining an amount of cumulative component information loss from H to each component, including the output component at Q, IL_{X}, IL_{Y}, . . . IL_{Q}, as well as component-level information loss IL_{XΔ}, IL_{YΔ}, . . . IL_{QΔ} (Step 330). IL_{Q} is equal to an end-to-end sum of the component-level information loss that is occurring at each component. Information cannot be gained and can only be lost within the Markovian channel. In the context of the radar system example, these sources of component information loss may include, for example, loss due to uncertainty in the sensing and/or feature extraction processes, as well as loss occurring from the decision process due to imperfect training. IL_{XΔ}, IL_{YΔ}, . . . IL_{QΔ} may be determined by apportioning the IL_{Q} determined in Step 330 among each component. Because IL_{Q} is equal to a sum of the component-level information loss i.e. the information loss that occurs at each link or component within the system, IL_{X}, IL_{Y}, . . . IL_{Q} may be used to determine IL_{XΔ}, IL_{YΔ}, IL_{QΔ}.

The next step in the method 300 is calculating a predicted overall system performance Pₑ and the predicted link performance i.e. the component probability of error Pₑ^{X}, Pₑ^{Y}, . . . Pₑ^{Q}) (Step 335). Using Fano's equality, cumulative information loss, which may be, for example 1-I(H;Q) and/or IL_{Q}, is correlated with the total amount of entropy associated with system uncertainties as determined in Step 320, with this correlation being characterized as at least one overall probability of error Pₑ for the nonlinear system i.e. the overall system performance. Using Fano's equality and the Data Processing Inequality together, Pₑ may be used to estimate a component-level probability of error Pₑ^{X}, Pₑ^{Y}, . . . Pₑ^{Q} for each component in the system. In Step 337, Pₑ^{X}, Pₑ^{Y}, . . . Pₑ^{Q} may then be correlated to IL_{XΔ}, IL_{YΔ}, IL_{QΔ}.

Steps 310 to Step 335 may be repeated until the number of instances of the statistically distributed of uncertainty parameters calculated in Step 310 are realized. In one embodiment, this iterative sampling process may comprise a Monte Carlo method in which L draws are taken from the distribution of modeled uncertainty parameters (Step 310).

Once a sufficient number of samples (L) have been obtained, the method 300 continues with determining the statistical distribution of each component probability of error due to the various sources of parameter uncertainty (Step 340). The variance and mean of the cumulative component information loss IL_{X}, IL_{Y}, . . . IL_{Q} calculated in Step 330 are used to determine the variance on the predicted performance at each link or component. A distribution is created for each source of uncertainty, providing the random mapping to the performance estimate Pₑ at each component Pₑ^{X}, Pₑ^{Y}, . . . Pₑ^{Q}.

The statistical distribution of the component probability of error is then used to compute the reliability of the component probability of error (Step 345), followed by termination of the method. The standard deviation σ_{Pe} _{^{x}}, σ_{Pe} _{^{Y}} . . . σ_{Pe} _{^{Q}} of the respective predicted component performance functions Pₑ^{X}, Pₑ^{Y}, . . . Pₑ^{Q} is used as a measure of reliability. In this manner, the presently disclosed method 300 may be used to estimate the reliability (or confidence) of a component-level probability of error for each component in the system, and this component-level probability of error and associated reliability may then be correlated to the component-level information loss. The presumption is that for a fixed H(H), maximizing I(H,Q) will minimize the equivocation H(H/Q) and thus minimize the probability of error Pₑ. Unknown parameters can affect performance estimates thus knowledge of this reliability is needed to effectively minimize Pₑ in design.

In addition, the presently disclosed method allows the determination of the relative contribution of each system uncertainty parameter to the component-level performance reliability, as well as a comparison of the performance reliability estimates determined in Step 345 to real world uncertainty sources. This determination can be very helpful in the traceability of the effects of uncertainty on the reliability of performance. The disclosed method of decomposition will allow for designers to identify where the uncertainty is having the most detrimental effect on performance reliability. The ability to perform this traceability at the component level will further allow component designers to design for the minimum effects of uncertainty.

In one embodiment, a method for computing component-level performance reliability and attributing the contribution of each system uncertainty parameter to the component-level performance reliability may begin with determining a real world statistical variation of the system uncertainty parameters. In this context, “real world” refers to information obtained using actual events and/or experiments. For example, continuing with the radar system example, a variety of uncertainties exist, many of which occur due to chance and are hence unknowable. Samples obtained under real world conditions are subject to a variety of these system uncertainty parameters (known and unknown), and the statistical variation of the system uncertainty parameters may be calculated as described above. Following determination of real world statistical variation of the system uncertainty parameters, the method continues with performing Monte-Carlo modeling of a plurality of the statistical uncertainty parameters for a plurality of settings to determine component-level information loss. This step may occur, for example, through many iterations of Steps 310 to 335 in FIG. 3A as described above, followed by calculating a component-level probability of error statistical distribution at each component as in Step 340 and calculating a component-level performance reliability based on a standard deviation of each component-level probability of error statistical distribution as in Step 345.

The contribution of each system uncertainty parameter is then correlated to the component-level performance reliability. This calculation may be performed, for example using Eq. (34) described herein. The independent nature of the individual system uncertainty parameters allows the effects of each parameter to be seen. Using the Data Processing Inequality, a decomposition of reliability may be obtained so that the decomposition of reliability effects may be seen at each component. These calculations may be used to determine how well the information sensing system performs when real world data is used and to determine the acceptability of performance reliability with respect to real world uncertainty sources.

The presently disclosed invention further includes methods for determining the optimal design of components of a nonlinear system in order to minimize information loss, while maximizing information flow and MI. Referring to FIG. 3B, the method begins with establishing an information loss budget for the complete system (Step 350) in terms of a desired performance, such as establishing a desired value for Pₑ^{Q}. The Pₑ^{Q} for the total system may be related directly to the total system cumulative information loss IL_{Q}. In Step 355, a predicted component/link loss (for example; IL_{XΔ}, IL_{YΔ}) is calculated, followed by calculation of a component/link performance (for example; Pₑ^{X}, Pₑ^{Y})(Step 360). Steps 355 and 360 may be accomplished, for example, using the method in FIG. 3A. The next step (Step 365) is to compare the Pₑ^{Q} calculated in Step 360 with the desired Pₑ^{Q} value determined in Step 350. If the calculated Pₑ^{Q} is within the information budget (“Yes”), the method terminates.

However, if the calculated Pₑ e exceeds the information loss budget (“No”), the method may continue with identifying one or more sources of information loss and information flow reduction i.e. bottlenecks (Step 370). In some embodiments, there are two or more of information loss and information flow reduction, and the method further includes the step of identifying the dominant source(s) of information loss and information flow reduction i.e. bottlenecks (Step 370). These dominant sources may be identified by ranking the various sources of uncertainty at each link/component (for example; IL_{XΔ}, IL_{YΔ}) based on their individual impact on cumulative component information loss and performance of the system.

The next step is determining the optimal component design to minimize Pₑ^{Q} and IL_{Q}, while maximizing I(H;Q) (Step 375) within the information budget via one or more tradeoffs between information flow and component design (described in more detail herein). Following determination of the optimal component design in Step 375, the method returns to Step 355 to continue component design iterations guided by relative levels of component information loss within a system component/link loss budget until a component design is determined that keeps the calculated Pₑ^{Q} within the desired information loss budget established in Step 350.

Fano-Based Information Theoretic Method (FBIT) and Data Processing Inequality: Fano's Inequality and the Data Processing Inequality, both of which are theorems from information theory, may be used in Step 335 of the method in FIG. 3A to quantify the effects of “uncertainty” and the associated alteration to the typical signature subspaces in terms of the flow of information and the impact to system performance. Fano's Inequality relates information theoretic quantities to the Pₑ (probability of error) criterion in for example, an object classification system, while the Data Processing Inequality allows the analysis of information flow from measured object returns through the signature sensing, signal processing architecture and into the decision stage. The Data Processing Inequality may be used to identify where information is lost and quantify the impact on system performance. In this manner, stages in the information processing pipeline where information is lost can be identified, analyzed, and optimized, leading to improvement in overall system performance.

Fano's Inequality provides a mathematical means to relate the MI between H and Q, I(H;Q), to a lower bound on Pₑ. Fano's Inequality may be written as an equality as in Equation (Eq.) (1):

H(Pₑ)=δ−Pₑ·log(N_{c}−1)+H(H/Q) (1)

In Eq. (1), Pₑ is a real random variable between 0 and 0.5 representing the probability of error of the decision algorithm. N_{c} is the discrete size of the alphabet of H and Q. H(H) is the Shannon entropy of the discrete random variable H. δ is a bias offset derived from asymmetries in the data and decision algorithm. Typically, δ is small and to a first approximation, may be neglected.

Theorem I: For N_{c}=2, Fano's equality can be written as H(Pₑ)=1−I(H;Q) +I(Q;V), where V is the binary discrete random variable representing the probability that the decision rule makes a correct decision. Using I(H;Q)=H(H)−H(H/Q) and Eq. (1), Eq. (2) may be obtained:

H(Pₑ)=δ−Pₑ·log(N_{c}−1)+H(H)−I(H;Q) (2)

The asymmetry factor in Eq. (2) may be computed directly from the output of the decision algorithm. Let δ=I(Q;V) for N_{c}=2; where V is the binary discrete random variable representing the probability that the decision rule makes a correct decision. V=1 when H=Q; otherwise V=0. Eq. (2) can then be written more completely for N_{c}=2 as in Eq. (3):

H(Pₑ)=1−I(H;Q)+I(Q;V) (3)

Eq. (3) may be written in terms of the inverse entropy function, F, as shown in Eq. (4):

Pₑ=F(H(H))−I(H;Q)+I(Q;V) (4)

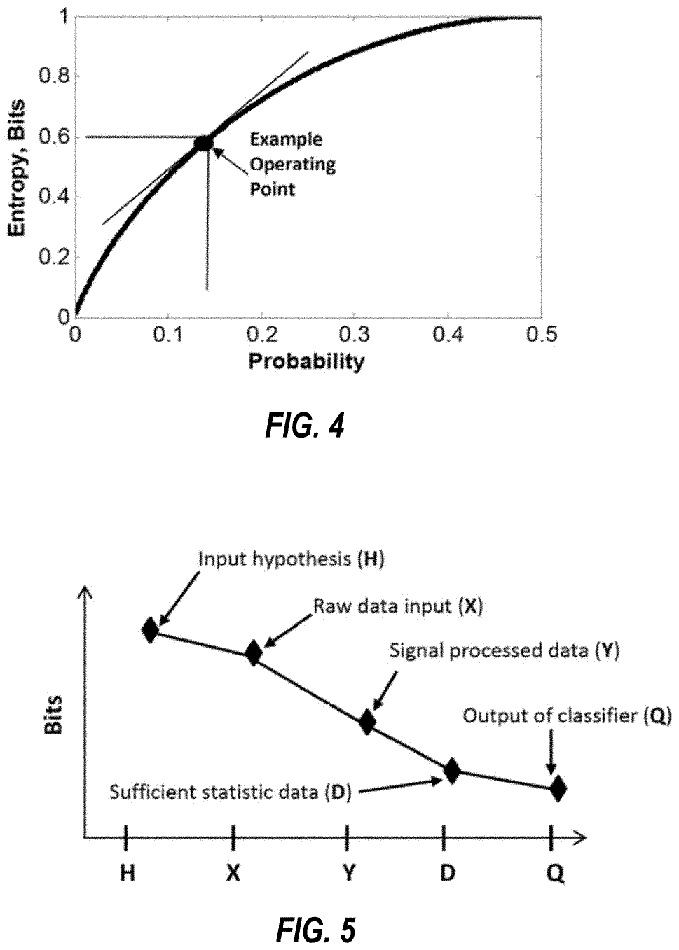

In Eq. (4), F is a deterministic, strictly monotonically increasing function that maps information theoretic quantities into the Pₑ at the corresponding operating point. The relationship of Pₑ to F(x) where x ∈ [0, 0.5] is shown in FIG. 4, which illustrates the binary entropy function. The quantity IL_{Q} in Eq. (5) is the end-to-end information loss for the system that is determined in Step 330 in FIG. 3A:

IL_{Q}=H(H)−I(H;Q)+I(Q;V) (5)

In general, minimizing the information loss minimizes the system Pₑ. The entropic quantity H(H) is determined by the a priori probabilities of the outcomes of the random variable H corresponding to the different target classes. δ is fixed by architectural considerations. Since F is a known function, the deterministic relation Pₑ=F(H(H)−I(H;Q)+I(Q;V)), for fixed H(H) and δ, determines the MI, I(H;Q), needed to achieve a specified Pₑ. For example, for an equiprobable binary hypothesis scenario, H(H)=1 Bit and I(Q;V)≈0, an approximation for Pₑ can be written as Eq. (6):

Pₑ≈F(1−i(H;Q)) (6)

Specifying a desired Pₑ determines the amount of allowed IL_{Q}. How the IL_{Q} budget is “spent” as information cascades from the input space at H to the classifier output space at Q can be traded off via component (link) design. FIG. 5 presents an abstract diagram indicating possible tradeoffs between component level design vs. information (Bits). Information losses within the channel can be studied with respect to various sources of uncertainty in Table 1.

The Data Processing Inequality states that information can only be lost in the channel as shown in Eq. (7):

I(H;\vec{X})≥I(H;\vec{Y})≥I(H;Q) (7)

Using the relationship in Eqs. (4) and (5), the loss associated with each link within the channel can be characterized as in Eq. (8):

H(H)−I(H;\vec{X})≤H(H)−I(H;\vec{Y})≤H(H)−I(H;Q) (8)

The approximation to the cumulative information loss at each link in the channel can then be written as below applying Eq. (5):

IL_{\vec{X}}≈H(H)−I(H;\vec{X}); [symbol] ∈|x| (9.a)

IL_{\vec{Y}}≈H(H)−I(H;\vec{Y}); \vec{Y}∈|Y| (9.b)

IL_{Q}≈H(H)−I(H;Q); Q ∈|Q| (9.c)

Theorem II: The respective information loss due to each link within a Markov chain H→X→Y→Q can then be approximated using Eqs. (10a-10c):

Loss due to Sensing≡IL_{SΔ}H(H)−I(H; \vec{X}) (10.a)

Loss due to Feature Extraction≡IL_{FΔ}≈I(H; \vec{X})−I(H; \vec{Y}) (10.b)

Loss due to Decision Rule≡IL_{DΔ}≈I(H; \vec{Y})−I(H;Q) (10.c)

Thus, the probability of error can be estimated at various points in the channel using the approximation in Eq. (6):

Pₑ^{X}≈F(H(H)−I(H; \vec{X}) (11.a)

Pₑ^{Y}≈F(H(H)−I(H; \vec{Y}) (11.b)

Pₑ ^{Q}≈F(H(H)−I(H;Q) (11.c)

Uncertainty In the Information Channel: The feature extraction f and decision rule d in FIG. 2 are designed to maximize I(H;Q), but it can be seen from Eq. (2) that sources of uncertainty introduced in the channel may result in a reduction in I(H;Q) and subsequently an increase in Pₑ. A decrease in I(H;Q) is always accompanied by an increase in H(Pₑ), resulting in a degradation to the realized Pₑ.

Referring to the radar system example, the loss at \vec{X}IL_{SΔ}, is due solely to the sensing process (source 1 in Table 1). The sensing uncertainty inherently alters the statistical support associated with \vec{X}ₙ, generating statistical independence between \vec{X}ₙ and \vec{X}, thus degrading the performance of the signature sensing process as quantified by Pₑ^{X} in Eq. (11a). The loss in information due to sensing uncertainty is then realized at \vec{X} as IL_{SΔ} in Eq. (10a) and is quantified by the entropy H(Pₑ^{X}):

H(Pₑ^{X})≈H(H)−I(H;\vec{X}) (12)

The level of statistical agreement between \vec{X} and \vec{X}′ will directly affect the loss in the channel due solely to the decision process (source 2 in Table 2), which is closely tied to the surrogate training process \vec{X}′. The sensing uncertainty sources in Table 1 are to some degree reproducible in the decision rule training process \vec{X}′. However, sources 1(b) and 1(c) in Table 1 are not fully reproducible in \vec{X}. The dissimilarity between \vec{X} and \vec{X}′ results in a decision rule d that is less than optimal. The application of d to the feature process \vec{Y} induces a loss in the channel due to imperfect training. The effects of decision uncertainty within the decision rule subspace are realized at Q as IL_{DΔ} as illustrated in FIG. 2. The decision uncertainty IL_{DΔ} can be interpreted in terms of the entropy H(Pₑ^{Q}) as in Eq. (13) and quantified as defined in Eq. (11.c).

H(Pₑ^{Q})≈H(H;Q)−H(Q) (13)

The resulting H(Pₑ^{Q}) provides the best possible performance for a given component design (radar sensor design, feature selection, algorithm design, and decision rule design). As stated above, \vec{X} is often not completely observable and a training surrogate \vec{X}′ is used to develop f and d. Under conditions such as those listed in uncertainty source 2 in Table 1, the surrogate representation \vec{X}′ used in the training of the decision rule results in a non-optimal d. This is represented by the altered entropic quantity H(Q′) and more importantly I(H;Q′). The alternate Markov chain H→\vec{X}→\vec{Y}→Q′ is shown as the dotted subspace H(Q′) in FIG. 1. The corresponding form of Eq. (3) can then be written as:

H(Pₑ′)=1−I(H;Q′)+I(Q′;V) (14)

Therefore since H(Pₑ′)≥H(Pₑ), I(H;Q′)−I(Q′;V)≤I(H;Q)−I(Q;V).

Corollary I: Information loss due to imperfect training, IL_{TΔ}, is then mathematically quantified in terms of the increase in entropy ΔH(Pₑ) resulting from a non-optimal design of f and d:

$$\begin{matrix}{IL}_{T Δ} = Δ H ( {P}_{e} ) = H ( {P}_{e}^{′} ) - H ( {P}_{e} ) \\ = - I ( H ; {Q}^{′} ) + I ( {Q}^{′} ; V ) + I ( H ; Q ) - I ( Q ; V )\end{matrix} \qquad ( 15 )$$

If it can be shown that I(Q;V)≅I(Q′;V) and that I(Q;V)<<H(H)−I(H;Q) and I(Q′;V)<<H(H)−I(H;Q′), then:

Imperfect Training Loss≡IL_{TΔ}≅I(H;Q)−I(H;Q′) (16)

The decrease in information flow due to imperfect training is illustrated in FIG. 1 as the reduction in overlap between the subspaces of H and Q.

Theorem III: The total loss in the channel is equal to the sum of link information loss:

IL_{Total}=IL_{SΔ}+IL_{FΔ}+IL_{DΔ}+IL_{TΔ} (17)

Definition 1: Any phenomenon producing an increase in I(H;Q) and a subsequent reduction in H(Pₑ) can be defined as a “system information gain” within the information channel. Any phenomenon producing a decrease in I(H;Q) resulting in an increase in H(Pₑ) is defined as a “system information loss.”

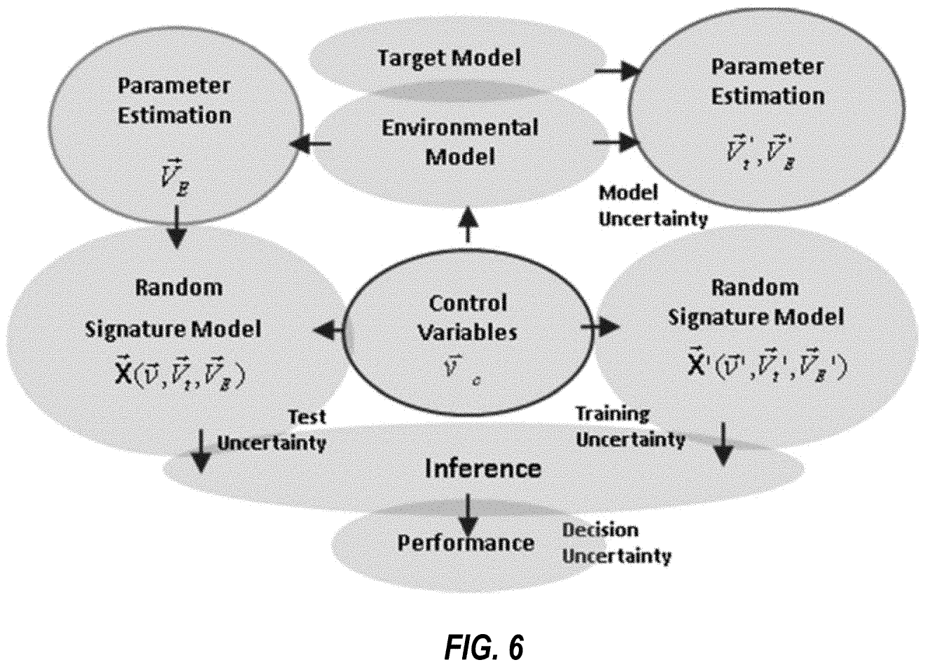

Propagating Effects of Uncertainty: Uncertainty propagation is the study of how uncertainty in the output of a model (numerical or otherwise) can be allocated to different sources of uncertainty in the model inputs, which are used in Step 310 of FIG. 3A to model the effects of a variety of system uncertainty parameters on various components of the system and the system as a whole. FIG. 6 provides an illustration of a modeling and analysis approach to uncertainty propagation within the sensitivity analysis and modeling of an information sensing system. The careful definition of variables plays a central role in case-controlled studies of the effects of uncertainty on system performance. The vector [symbol] represents the control parameters of interest within computer-generated experiments. Continuing to use the HRR sensor system example, absent the uncertainties identified in Table 1, the effects of selected values for [symbol] on the deterministic mapping function Pₑ^{X} [symbol] in Eq. (11.a) are certain. Further experimentation involving the unknowable random environmental and position estimation effects in sensing are best studied statistically. Thus, the respective estimated random input parameters of \vec{V}_{E} and \vec{V}ₜ are introduced, resulting in the mapping to the random signature process \vec{X}( [symbol] , \vec{V}_{E}, \vec{V}ₜ). The sensing uncertainty is then subsequently propagated into the random feature process \vec{Y} ( [symbol] , \vec{V}_{E}, \vec{V}ₜ) and ultimately to the decision process Q( [symbol] , \vec{V}_{E}, \vec{V}ₜ). For brevity, \vec{Y}(( [symbol] , \vec{V}_{E}, \vec{V}ₜ) is written as \vec{Y} and Q( [symbol] , \vec{V}_{E}, \vec{V}ₜ) is written as Q.

The distributions associated with the input parameters in \vec{V}_{E} and \vec{V}ₜ are estimated from experimental data. The estimated parameters become factors within a Monte Carlo simulation. The cumulative link information loss as quantified within Eq. (5) and approximated in Eqs. (9.a), (9.b), (9.c) then become random variables as shown:

IL_{\vec{X}}≈H(H)−I(H; \vec{X}(( [symbol] , \vec{V}_{E}, \vec{V}ₜ)); (18.a)

IL_{\vec{Y}}≈H(H)−I(H; \vec{Y}( [symbol] , \vec{V}_{E}, \vec{V}ₜ)); (18.b)

IL_{Q}≈H(H)−I(H; Q ( [symbol] , \vec{V}_{E}, \vec{V}ₜ)); (18.c)

Similarly, the link information loss IL_{SΔ}, IL_{FΔ}, and IL_{DΔ} in Eqs. (11.a), (11.b), and (11.c) also become random variables.

The unknowable characteristics of the observed signature process \vec{X} are realized within the input variables to the modeled training process \vec{X}′ ( [symbol] , \vec{V}_{E} ,\vec{V}Δₜ). If it is assumed that [symbol] ≠ [symbol] , \vec{V}_{E}′≠\vec{V}_{E}, \vec{V}ₜ′≠\vec{V}ₜ, then the mapping to the non-optimal decision rule will be d( [symbol] , \vec{V}_{E}′, \vec{V}ₜ′), which will be written as d for brevity. The decision rule d is applied to \vec{Y} ( [symbol] , \vec{V}_{E}, \vec{V}ₜ) generating Q′( [symbol] , \vec{V}_{E}, \vec{V}ₜ′), written as Q′, while the optimal decision rule dₒₚₜ generates Q( [symbol] , \vec{V}_{E}, \vec{V}ₜ). Each realization of d and dₒₚₜ resulting from each ensemble \vec{X}′(\vec{v}_{c}′, \vec{V}_{E}′, \vec{V}ₜ′) and \vec{X}( [symbol] , \vec{V}_{E}, \vec{V}ₜ), respectively, in the Monte Carlo simulation will result in the randomization of the imperfect training loss function in Eq. (19) and the randomization of the cumulative loss function in Eq. (20):

IL_{TΔ}≡I(H;Q)−I(H;Q′) (19)

IL_{Q}′≈H(H)−I(H;Q′) (20)

In Eq. (19), the special case of \vec{V}_{E}′=\vec{V}_{E} and \vec{V}ₜ′=\vec{V}ₜ, the loss due to the optimal training of d=dₒₚₜ yields IL_{TΔ}=0 and IL_{Q}′=IL_{Q}. To narrow the focus of analysis, the training space ( [symbol] , \vec{V}_{E}′, \vec{V}ₜ′) will be considered fixed and thus will become a component of the system control parameter [symbol] . Therefore, d becomes fixed by design as d.

Independent Sources of Uncertainty Loss: Loss due to isolated sources of uncertainty within the channel can be computed to provide a means to characterize the relative impacts to information flow at various points in the channel. The various sources of sensing uncertainty induce information loss in the channel as characterized by the random link loss functions IL_{SΔ}, IL_{FΔ}, IL_{DΔ}, and IL_{TΔ}. The prior distributions on the random parameters within \vec{V}_{E} and \vec{V}ₜ are propagated to the respective loss functions using Monte Carlo simulation.

Definition 2: The expected value of the link information loss can be written as the expected values of the individual random loss components as in Eqs. (21.a)-(21.d):

$$\begin{matrix}{μ}_{{IL}_{{S}_{Δ}}} = E \{ {IL}_{S Δ} \} & ( 21. a ) \\ {μ}_{{IL}_{{F}_{Δ}}} = E \{ {IL}_{F Δ} \} & ( 21. b ) \\ {μ}_{{IL}_{{D}_{Δ}}} = E \{ {IL}_{D Δ} \} & ( 21. c ) \\ {μ}_{{IL}_{{T}_{Δ}}} = E \{ {IL}_{T Δ} \} & ( 21. d )\end{matrix}$$

The sensing uncertainty factors within \vec{V}_{E} and \vec{V}ₜ are assumed to be independent. Given that the total loss function IL_{Total} can account for multiple independent sources of uncertainty within the parameter space of ( [symbol] , \vec{V}_{E}, \vec{V}ₜ), the variance on IL_{Total} is the sum of the individual variances within the components of IL_{Total}.

Corollary II: Assuming ne factors within \vec{V}_{E} and nt factors within \vec{V}ₜ, the link loss variance can be decomposed as given in Eqs. (22.a)-(22.d):

$$\begin{matrix}{σ}_{{IL}_{{S}_{Δ}}}^{2} = {σ}_{{IL}_{{S}_{{Δ}_{( {V}_{E 1} )}}}}^{2} + … {σ}_{{IL}_{{S}_{{Δ}_{( {V}_{{n}_{e}} )}}}}^{2} + {σ}_{{IL}_{{S}_{{Δ}_{( {V}_{t 1} )}}}}^{2} + … {σ}_{{IL}_{{S}_{{Δ}_{( {V}_{{n}_{t}} )}}}}^{2} & ( 22. a ) \\ {σ}_{{IL}_{{F}_{Δ}}}^{2} = {σ}_{{IL}_{{F}_{{Δ}_{( {V}_{E 1} )}}}}^{2} + … {σ}_{{IL}_{{F}_{{Δ}_{( {V}_{{n}_{e}} )}}}}^{2} + {σ}_{{IL}_{{F}_{{Δ}_{( {V}_{t 1} )}}}}^{2} + … {σ}_{{IL}_{{F}_{{Δ}_{( {V}_{{n}_{t}} )}}}}^{2} & ( 22. b ) \\ {σ}_{{IL}_{{D}_{Δ}}}^{2} = {σ}_{{IL}_{{D}_{{Δ}_{( {V}_{E 1} )}}}}^{2} + … {σ}_{{IL}_{{D}_{{Δ}_{( {V}_{{n}_{e}} )}}}}^{2} + {σ}_{{IL}_{{D}_{{Δ}_{( {V}_{t 1} )}}}}^{2} + … {σ}_{{IL}_{{D}_{{Δ}_{( {V}_{{n}_{t}} )}}}}^{2} & ( 22. c ) \\ {σ}_{{IL}_{{T}_{Δ}}}^{2} = {σ}_{{IL}_{{T}_{{Δ}_{( {V}_{E 1} )}}}}^{2} + … {σ}_{{IL}_{{T}_{{Δ}_{( {V}_{{n}_{e}} )}}}}^{2} + {σ}_{{IL}_{{T}_{{Δ}_{( {V}_{t 1} )}}}}^{2} + … {σ}_{{IL}_{{T}_{{Δ}_{( {V}_{{n}_{t}} )}}}}^{2} & ( 22. d )\end{matrix}$$

Definition 3: The expected value of the cumulative link information loss can then be written as the expected values of the individual random cumulative loss components as in Eqs. (23.a)-(23.d), which may be used to obtain the cumulative component information loss as in Step 330 in FIG. 3A:

μ_{IL}_{_{\vec{X}}}=E {IL_{\vec{X}}} (23.a)

μ_{IL}_{_{\vec{Y}}}=E {IL_{\vec{Y}}} (23.b)

μ_{IL}_{_{Q}}=E {IL_{Q}} (23.c)

μ_{IL}_{_{Q}}′=E {IL_{Q}′} (23.d)

Corollary III: Assuming nₑ factors within \vec{V}_{E} and nₜ factors within \vec{V}ₜ, the cumulative link loss variance can be decomposed as given in Eqs. (24.a)-(24.d):

$$\begin{matrix}{σ}_{{IL}_{\vec{X}}}^{2} = {σ}_{{IL}_{{\vec{X}}_{( {V}_{E 1} )}}}^{2} + … {σ}_{{IL}_{{\vec{X}}_{( {V}_{{n}_{e}} )}}}^{2} + {σ}_{IL {\vec{X}}_{( {V}_{t 1} )}}^{2} + … {σ}_{{IL}_{{\vec{X}}_{( {V}_{{n}_{t}} )}}}^{2} & ( 24. a ) \\ {σ}_{{IL}_{{\vec{Y}}_{Δ}}}^{2} = {σ}_{{IL}_{{\vec{Y}}_{( {V}_{E 1} )}}}^{2} + … {σ}_{{IL}_{{\vec{Y}}_{( {V}_{{n}_{e}} )}}}^{2} + {σ}_{{IL}_{{\vec{Y}}_{( {V}_{t 1} )}}}^{2} + … {σ}_{{IL}_{{\vec{Y}}_{( {V}_{{n}_{t}} )}}}^{2} & ( 24. b ) \\ {σ}_{{IL}_{Q}}^{2} = {σ}_{{IL}_{{Q}_{( {V}_{E 1} )}}}^{2} + … {σ}_{{IL}_{{Q}_{( {V}_{{n}_{e}} )}}}^{2} + {σ}_{{IL}_{{Q}_{( {V}_{t 1} )}}}^{2} + … {σ}_{{IL}_{{Q}_{( {V}_{{n}_{t}} )}}}^{2} & ( 24. c ) \\ {σ}_{{IL}_{{Q}^{′}}}^{2} = {σ}_{{IL}_{{{Q}^{′}}_{( {V}_{E 1} )}}}^{2} + … {σ}_{{IL}_{{{Q}^{′}}_{( {V}_{{n}_{e}} )}}}^{2} + {σ}_{{IL}_{{{Q}^{′}}_{( {V}_{t 1} )}}}^{2} + … {σ}_{{IL}_{{{Q}^{′}}_{( {V}_{{n}_{t}} )}}}^{2} & ( 24. d )\end{matrix}$$

Propagating Link Loss to Link Performance: The variance and mean of the random cumulative loss components IL_{\vec{X}}, IL_{\vec{Y}}, IL_{Q} and IL_{Q}′ are used directly to determine the variance on the performance at the random link performance components Pₑ^{\vec{X}}, Pₑ^{\vec{Y}}, Pₑ^{Q}, and Pₑ^{Q}′. The Maximum Likelihood Estimate (MLE) of Pₑ is inferred at each realization of the sufficient statistical support about ( [symbol] , \vec{V}_{E}, \vec{V}ₜ), providing the random mapping to performance Pₑ at each link as in Step 335 in FIG. 3A.

Corollary IV: Given sufficient sampling of the space of \vec{V}_{E} and \vec{V}ₜ within the finite alphabet |x| and |Y|, the environmental and position estimate uncertainty factors result in the respective random performance at \vec{X} and \vec{Y} given by functions Pₑ^{X}( [symbol] , \vec{V}_{E}, \vec{V}ₜ) and Pₑ^{Y}( [symbol] , \vec{V}_{E}, \vec{V}ₜ) as in Eqs. (25) and (26):

Pₑ^{\vec{X}}≡Pₑ^{X} ( [symbol] , \vec{V}_{E}, \vec{V}ₜ)≈F(IL_{\vec{X}}) (25)

Pₑ^{\vec{Y}}≡Pₑ^{Y} ( [symbol] , \vec{V}_{E}, \vec{V}ₜ)≈F(IL_{\vec{Y}}) (26)

If the conditions of Corollary IV hold and perfect training conditions are assumed where [symbol] = [symbol] , \vec{V}_{E}′=\vec{V}_{E}, \vec{V}ₜ′=\vec{V}ₜ, then the mapping to the decision rule dₒₚₜ will be optimal.

Corollary V: The output of the discrete random variable Q (from the finite alphabet |Q|) is driven by the inferred decision out of the application of each realization of \vec{Y} to dₒₚₜ. The random performance function Pₑ^{Q}( [symbol] , \vec{V}_{E}, \vec{V}ₜ) can be expressed as random realization of the information loss in the channel, IL_{Q} in Eq. (18.c). Using the approximation form of Eq. (13) (assume I(Q;V)≈0), the random performance function Pₑ^{Q} is given by Eq. (27).

Pₑ^{Q}≡Pₑ^{Q}( [symbol] , \vec{V}_{E}, \vec{V}ₜ)≈F {IL_{Q}} (27)

The approximation in Eq. (27) can be replaced by an equality using the full representation in Eq. (4):

Pₑ^{Q}=F {IL_{Q}+I(Q;V)} (28)

In Eqs. (27) and (28), the relaxation of the constraint \vec{V}_{E}′=\vec{V}_{E} and \vec{V}ₜ′=\vec{V}ₜ expands the study of the effects of uncertainty to the loss due to the non-optimal training of d.

Corollary VI: The output of the discrete random variable Q′ (from the finite alphabetly |Q|) is driven by the inferred decision out of the application of each realization of \vec{Y} to d. The random performance function Pₑ^{Q}′( [symbol] , \vec{V}_{E}, \vec{V}ₜ) can be expressed as random realization of the information loss in the channel, H(H)−I(H;Q′). Fixing the suboptimal decision rule d( [symbol] =, β_{c}, \vec{V}_{E}′=β_{E}, \vec{V}ₜ′=βₜ) and using the approximation form of Eq. (4) (assume I(Q;V′) ≈0), the random performance function Pₑ^{Q}′ is given by Eq. (29):

Pₑ^{Q}′≡Pₑ^{Q}′( [symbol] , \vec{V}_{E}, \vec{V}ₜ)≈F{IL_{Q}′}=F{H(H)−I(H;Q′)} (29)

The approximation in Eq. (29) is replaced by an equality using the full representation in Eq. (4):

Pₑ^{Q}′≡Pₑ^{Q}′( [symbol] , \vec{V}_{E}, \vec{V}ₜ)=f{H(H)−I(H;Q′)+I(Q′;V′)} (30)

Definition 4: The expected link performance under control parameters [symbol] and in the presence of sensing uncertainty (\vec{V}_{E}, \vec{V}ₜ) is defined as the expectation of the random link performance components Pₑ^{\vec{X}}, Pₑ^{\vec{Y}}, Pₑ^{Q}, and Pₑ^{Q}′.

$$\begin{matrix}{μ}_{{P}_{{e}_{\vec{X}}}} = E \{ {P}_{e}^{\vec{X}} \} & ( 31. a ) \\ {μ}_{{P}_{{e}_{\vec{Y}}}} = E \{ {P}_{e}^{\vec{Y}} \} & ( 31. b ) \\ {μ}_{{P}_{{e}_{Q}}} = E \{ {P}_{e}^{Q} \} & ( 31. c ) \\ {μ}_{{P}_{{e}_{{Q}^{′}}}} = E \{ {P}_{e}^{{Q}^{′}} \} & ( 31. d )\end{matrix}$$

Given a sufficient number of Monte Carlo samples over the random parameters in \vec{V}_{E} and \vec{V}ₜ, the standard deviation of the random link component performance function is used as a measure of reliability. Reliability is interpreted as 95% confidence that any estimate would fall within the bounds of one standard deviation.

Definition 5: Reliability in predicted link performance is defined as the standard deviation (σ_{P}_{ₑ}^{\vec{X}}, σ_{P}_{ₑ}^{\vec{Y}}, σ_{P}_{ₑ}^{Q}, and σ_{P}_{ₑ}^{Q}′) of the respective random cumulative link performance associated with Pₑ^{\vec{X}}, Pₑ^{\vec{Y}, P}ₑ^{Q}, and Pₑ^{Q}′. The variability in link performance is defined as the square of the reliability; σ_{P}_{ₑ}_{^{\vec{X}}}², σ_{P}_{ₑ}_{^{\vec{Y}}}², σ_{P}_{ₑ}_{^{Q}}², and σ_{P}_{ₑ}_{^{Q}}²′.

Uncertainty in Performance: The independent sources of uncertainty contributing to σ_{IL}_{_{\vec{X}}}² n Eq. (24.a) are individually functionally mapped to the variance on the random performance function Pₑ^{\vec{X}} to determine the respective effects on the reliability of the predicted link performance estimate as in Step 340 in FIG. 3A. The uncertainty is passing through the transcendental relationship between IL_{\vec{X}} and Pₑ^{\vec{X}}. The nature of the nonlinear relationship makes it difficult to commute the independent loss variance sources analytically. It is important to relate the independent sources of uncertainty underlying σ_{IL}_{_{\vec{X}}}² to the corresponding set of variances that combine to equal the variance on Pₑ^{\vec{X}}.

It is possible to approximate the inverse entropy function (F) by a linear relationship about the mean of IL_{\vec{X}}: F(IL_{\vec{X}})=a+b·(IL_{\vec{X}}). The mean and variance of the approximation are then E[F(IL_{\vec{X}})]=a+b(μ_{IL}_{_{\vec{X}}}) and Var[E(IL_{\vec{X}})]=b². (σ_{IL}_{_{\vec{X}}}²).

Using established approximation techniques, the first order Taylor expansion of F around the mean μ_{IL}_{_{\vec{X}}} of IL_{\vec{X}} is equal to:

F(IL_{\vec{X}})≈F(μ_{IL\vec{X}})+F′(μ_{IL}_{_{\vec{X}}})·(IL_{\vec{X}}−μ_{IL}_{_{\vec{x}}}) (32)

Using the Taylor Series expansion in Eq. (32), the approximation for E[F(IL_{\vec{X}})] and Var[F(IL_{\vec{X}})] are:

E[F(IL_{\vec{X}})]=E[Pₑ^{\vec{X}}]≈F(μ_{IL\vec{X}})=H⁻¹(μ_{IL}_{_{\vec{X}}}) (33)

Var[F(IL_{\vec{X}})]=σ_{P}_{ₑ}_{^{\vec{X}}}²≈{F′(μ_{IL}_{_{\vec{X}}})}²·(σ_{IL\vec{X}}²) (34)

and F′(μ_{IL}_{_{\vec{X}}}can be shown to equal:

$${F}^{′} ( {μ}_{{IL}_{X}^{\to }} ) = log [ \frac{1}{[ \frac{{H}^{- 1} ( {μ}_{{IL}_{\vec{X}}} )}{1 - {H}^{- 1} ( {μ}_{{IL}_{\vec{X}}} )}} ]$$

Assuming nₑ factors within \vec{V}_{E} and nₜ factors within \vec{V}ₜ, the cumulative link loss variance components given in Eq. (24.a) are applied to Eq. (34):

$${σ}_{{P}_{e}^{\vec{X}}}^{2} \approx {\{ {F}^{′} ( {μ}_{{IL}_{\vec{X}}} ) \}}^{2} \cdot \{ {σ}_{{IL}_{{\vec{X}}_{( {V}_{E 1} )}}}^{2} + … {σ}_{{IL}_{{\vec{X}}_{( {V}_{{n}_{e}} )}}}^{2} + {σ}_{IL {\vec{X}}_{( {V}_{t 1} )}}^{2} + … {σ}_{{IL}_{{\vec{X}}_{( {V}_{{n}_{t}} )}}}^{2} \qquad ( 35 )$$

The variance on the performance estimate Pₑ^{\vec{X}} is then decomposed into the individual sources of sensing uncertainty being propagated through the decision space at \vec{X}.

$${σ}_{{P}_{e}^{\vec{X}}}^{2} \approx {σ}_{{P}_{{e}_{E}}^{\vec{X}}}^{2} + … {σ}_{{P}_{{e}_{{n}_{e}}}^{\vec{X}}}^{2} + {σ}_{{P}_{{e}_{t}}^{\vec{X}}}^{2} + … {σ}_{{P}_{{e}_{{n}_{t}}}^{\vec{X}}}^{2} \qquad ( 36 )$$

Similar methods are applied to the independent contributions to the sensing uncertainty of \vec{V}_{E} and \vec{V}ₜ comprising the variances

$${σ}_{{IL}_{{\vec{Y}}_{Δ}}}^{2} , {σ}_{{IL}_{Q}}^{2} , and {σ}_{{IL}_{{Q}^{′}}}^{2}$$

at \vec{Y}, Q, and Q′ respectively.

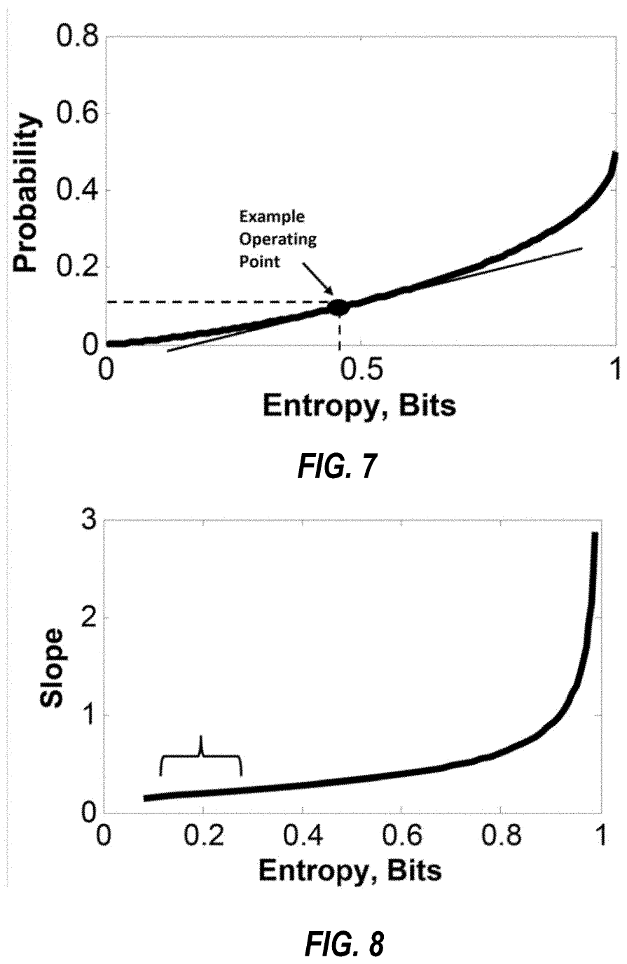

Stability of the Linear Approximation: The validity of the linear approximation in Eq. (34) requires σ_{IL}_{_{\vec{X}}}² be small. Thus, the contributing sources of sensing uncertainty within σ_{IL}_{_{\vec{X}}}² mustbe individually small. Given that the regime of interest is one where μ_{IL}_{_{\vec{X}}} and thus E[ Pₑ^{\vec{X}}] are small, the derivative (slope) evaluated at μ_{IL}_{_{\vec{X}}} is relatively small. The slope within this regime is illustrated in FIG. 7 for an arbitrary operating point (the inverse Entropy Function; f(z)=H⁻¹(w)). The slope

$$\frac{{dH}^{- 1} ( w )}{dw}$$

is plotted in FIG. 8 for w ∈[0, 1].

Dimensionality and Computing: The computation of the entropy of \vec{X} involves the joint probability mass function (PMF) of the random multivariate \vec{X} and is complicated by the large dimensional nature of the observation mapping H→\vec{X}. It is desired to compute the discrete entropy for \vec{X} absent any assumption regarding dependence between the respective dimensions of \vec{X}. If the \vec{X} space consists of K random variables (dependent or independent) and the random variable Xₖ; k ∈ {1, K} has nb distinct bins (statistical divisions), then the size of the alphabet of \vec{X}, |\vec{x}| is given in Eq. (37):

|\vec{x}|=Πₖ₌₁^{k=K}nₖ (37)

For example, if K=3 and nₖ=2=n_{b} for all k, |\vec{x}|=2·2·2=8.

The joint PMF of \vec{X}, p (xₖ_{_{N}}^{j}); k ∈ {1, K}, j ∈ {1,n_{b}} is generated from a finite N sample ensemble and discretely binned with nb statistical divisions within each of the K elements of \vec{X}. Stable entropic estimates require the statistics of the multivariate PMF be sampled sufficiently. A reasonable example in the context of the HRR example with K=10 and n_{b}=5 for all k would present a theoretical typical set of 5¹⁰=9,765,625. The typical set represents the set of most probable events and contains almost all of the probability as the number of samples increases. In the case of the radar example developed here, this would be the set of most probable signature amplitude combinations for all K dimensions of \vec{X}. To generate a meaningful sample size for a PIVIF of this size, at least 10 times the typical set would need to be produced, which equals approximately 100 million samples. Thus K and n_{b} drive the dimensionality of \vec{X} and subsequently the sampling requirements for each ensemble within the Monte Carlo simulation.

A high dimensional problem is one where the alphabet of \vec{X}, |\vec{x}|, underlying the random process far exceeds the number of samples observed (N), i.e.; |\vec{x}|>>N. Sensing systems typically operate within this high dimensional signature data space of |\vec{x}|. The high dimension arises due to factors within the space \vec{X}( [symbol] , \vec{V}_{E}, \vec{V}ₜ). Hypothesis testing and inference within the high dimensional space of \vec{X} in turn leads to large sampling requirements to adequately determine the underlying statistical nature of the phenomenon under study. Without accurate determination of the underlying system statistics, poorly performing hypothesis tests and/or parameter estimation occur (Bias/Variance tradeoff).

The number of statistical bins, n_{b}, within the discrete sampling of the K element joint PMF of \vec{X} also has a significant effect on |\vec{x}| as well as the entropy computation of \vec{X}. An increase in size of n_{b} in \vec{X} will result in an increase in the entropy of \vec{X}. However, in the limit, the value for I(H; \vec{X}) as a function of nb asymptotes to a constant value after one reaches the full intrinsic dimensionality of the subspace of I(H; \vec{X}). This will be true for I(H; \vec{Y}), I(H;Q), and I(H;Q′) as well. A method for determining the intrinsic dimensionality of \vec{X} is then needed to guide the selection of N.

Sample Size and Minimum Sampling Requirements: The methods used to determine the minimum sampling requirements for entropy estimation and the variance parameters of these entropy estimations (Step 315 in FIG. 3A) are now described. In one embodiment, a method for determining component level ensemble sampling requirements N_{M} begins with determining a set of test criteria for maximum sampling uncertainty of the component-level information loss relative to the component-level probability of error statistical distributions, followed by determining a sample ensemble size N_{M} for the component-level information loss using a phase transition method and computing the component-level performance reliability using a numerical simulation method such as Monte Carlo modeling on an ensemble size N_{M}.

The link performance variability estimate at each of the respective links, σ_{P}_{ₑ}_{^{\vec{X}}}², σ_{P}_{ₑ}_{^{\vec{Y}}}², σ_{P}_{ₑ}_{^{Q}}², and σ_{P}_{ₐ}_{^{Q}}²′ are generated though a sufficient number of draws from the respective random link performance functions Pₑ^{\vec{X}}, Pₑ^{\vec{Y}}, Pₑ^{Q}, and Pₑ^{Q}′. Each draw involves the estimation of an entropic quantity computed from PMF p(xₖ_{_{N}}^{j}) based on the N sample ensemble taken from \vec{X}. The estimate of the link performance variability at \vec{X}, \hat{σ}_{P}_{ₑ}_{^{\hat{x}}}², , is written more precisely as in Eq. (38):

$${σ}_{{\hat{P}}_{{e}_{N}}^{\vec{X}}}^{2}$$

is defined as the N sample estimation variance or “sampling uncertainty”

$${\hat{σ}}_{{P}_{e}^{\vec{X}}}^{2} = {σ}_{{P}_{e}^{\vec{X}}}^{2} + {σ}_{{\hat{P}}_{{e}_{N}}^{\vec{X}}}^{2} \qquad ( 38 )$$

associated with the true variability σ_{P}_{ₑ}_{^{\vec{X}}}². Eq. (38) can be written as

$${\hat{σ}}_{{P}_{e}^{\vec{X}}}^{2} = {σ}_{{P}_{e}^{\vec{X}}}^{2} = ( 1 + {σ}_{{\hat{P}}_{{e}_{N}}^{\vec{X}}}^{2} / {σ}_{{P}_{e}^{\vec{X}}}^{2} ) .$$

For the high dimensional problem, N must be large enough for:

$$\frac{{σ}_{{\hat{P}}_{{e}_{N}}^{\vec{X}}}^{2}}{{σ}_{{P}_{e}^{\vec{X}}}^{2}} << 1 \qquad ( 39 )$$

The objective then is to produce link reliability estimates that are within this regime. The choice of N must be selected to ensure the uncertainty of the entropic estimate is much less than the reliability limits realized due to various factors within ( [symbol] , \vec{V}_{E}, \vec{V}ₜ) under study. That is, the ensemble size N of \vec{X}, \vec{Y}, Q, and Q′ should be sufficiently large to ensure that the variance of the estimate falls within three significant digits of the variability levels

$$( {σ}_{{IL}_{{\vec{Y}}_{Δ}}}^{2} , {σ}_{{IL}_{Q}}^{2} , and {σ}_{{IL}_{{Q}^{′}}}^{2} ) .$$

Thus for the case of variability at \vec{X}, it is desired that

$$\frac{{σ}_{{\hat{P}}_{{e}_{N}}^{\vec{X}}}^{2}}{{σ}_{{P}_{e}^{\vec{X}}}^{2}} < .001 .$$

As stated above, |\vec{x}| in particular, can grow to large levels and as such the number of samples required will grow as well. Given that the sampling ensemble size N of \vec{X} is likewise imposed on \vec{Y} and Q, the following analysis is focused on the process at \vec{X}.

From FIG. 8, it is evident that the slope at an operating point within this regime will be on the order of 0.25, affording reduced sensitivity to effects of the size of σ_{IL}_{_{\vec{X}}}².

Phase Transitions and the Typical Set: The entropy computation requires the development of the joint mass function associated with the multi-variate \vec{X}, p(xₖ^{j}); j ∈ {1: n_{b}}, k ∈ {1 K}. The development of this mass function assumes no independence between the K indices of \vec{X} and is performed using a “linked list” approach to limit the memory requirements during computation. A doubly linked list implementation with a hash table search approach yields a computational complexity of O(N). The Miller-Madow estimate provides a faster convergence over the MLE method for finite sample estimates.

Maximum Likelihood Estimate of H(\vec{X}ₖ):

$${\hat{H}}_{{MLE}_{N}} ( {X}_{k} ) = {\sum }_{j = 1}^{{n}_{b}} - p ( {x}_{{k}_{N}}^{j} ) {log}_{2} \{ p ( {x}_{{k}_{N}}^{j} ) \} \qquad ( 40 )$$

Miller-Madow Estimate of H(\vec{X}ₖ) (note: M₊=number of statistical bins for which p(xₖ_{_{N}}^{j})≠0:

Ĥ_{MM}_{_{N}} (Xₖ)=Ĥ_{MLE}_{_{N}}(Xₖ)+{1/(2N)}{M₊−1} (41)

The N sample estimates for Ĥ_{MLE}_{_{N}} (Xₖ) and Ĥ_{MN}_{_{N}} (Xₖ) are generated from the joint mass function, p(xₖ^{j}); j ∈{1: n_{b}}, k ∈{1:K}.

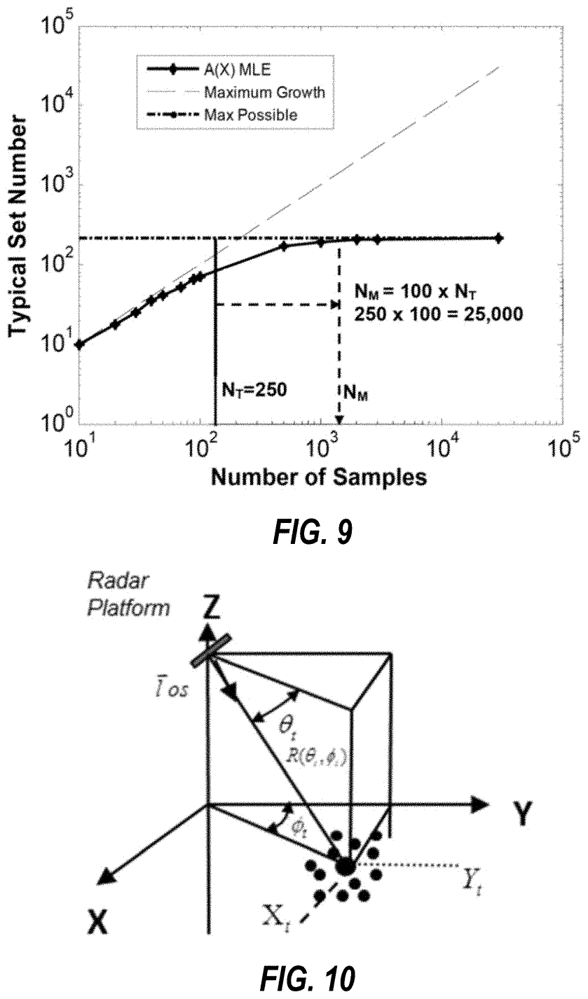

Phase transitions within the growth trajectory of the estimated entropy with increasing N are useful in defining the alphabet size |\vec{x}. The following illustration demonstrates the usefulness of this approach. The signature process under evaluation will be constructed by design such that the actual entropy value is known. The multivariate random signature vector \vec{X} is modeled to be uniformly distributed (standard uniform {0,1}) with n_{b}=6 (all indices of \vec{X}) and K=3. The theoretical maximum value of the entropy of \vec{X} is then log2(n_{b}^{K}) or log₂(6³)=7.7549 Bits. In FIG. 9, the estimate of the discrete entropy of \vec{X} is incrementally generated for an increasing number of samples. The typical set of \vec{X} is plotted for each increment. The typical set A_{ε}=2^{H(\vec{x})} is computed from the discrete entropy H(\vec{X}). Each of the estimated values for the typical set of \vec{X} asymptote at the maximum dimensionality of \vec{X} where the theoretical values of H(\vec{X})=7.7549 Bits and A_{ε}=216.

Initially, the samples are filling the open high dimensional space of \vec{X} in a uniform fashion. The linear dashed line represents the log2(N) growth of the entropy associated with this uniform distribution. Note that the actual achieved entropy computation begins to diverge from a uniform distribution. Only after the samples of \vec{X} begin to accumulate in the bin space of the joint mass function of \vec{X} does this transition occur. This phase transition point represents the point at which the fundamental statistics of \vec{X} change.

The phase transition point is determined from the intersection of the line tangent to the linear portion of the typical set profile and the line tangent to the asymptotic portion of the profile. The number of samples coinciding with this phase transition point is N_{T}. For the example here, N_{T} is found to be approximately 250 as illustrated in FIG. 9, which illustrates the phase transitions in \vec{X} and computing the minimum sampling N_{M} using the MLE method. The minimum number of samples, N_{M}, is taken to be 100 times the value of N_{T}. In this example, N_{M} is found to be 25,000. The Miller-Madow estimate for entropy Ĥ_{MM}_{_{N}} (Xₖ) is used for all entropic computation within the remaining body of this analysis.

Sampling Uncertainty for Probability of Error Estimate: Since the random estimation error variable is essentially the sum of many independently distributed random variables, the estimation error is Gaussian. The standard deviation of the Gaussian distribution of Î(H;\vec{X}), will then scale as a function of 1/N. Thus the variance on the estimate Î(H; \vec{X}),

$${σ}_{{\hat{I} ( H ; x )}_{2 {N}_{T}}}^{2} ,$$

can be scaled to a large sample size (σ_{Î(H,x)}_{_{N}}²). The standard deviation of the estimate \hat{P}ₑ^{X} can be determined from the independent contributions of H(H) and Î(H; \vec{X}) shown in Eq. (42).

\hat{P}ₑ^{X}≈H⁻¹(H(H)−Î(H; \vec{X})) (42)

For the equal probable binary hypothesis case, H(H) is equal to 1 Bit. Therefore the sampling uncertainty

$${σ}_{{\hat{P}}_{{e}_{N}}^{\vec{X}}}^{2}$$

is a function only of σ_{Î(H;x)}_{_{N}}².

As previously noted, the inverse entropy function in Eq. (42) is a transcendental function and as such the variance on the estimate \hat{P}ₑ^{X},

$${σ}_{{\hat{P}}_{{e}_{N}}^{\vec{X}}}^{2} ,$$

can be very difficult to determine analytically. Following a similar line of analysis found in Eqs. (33) and (34), the mean and variance of \hat{P}ₑ^{X} can be calculated as:

$$\begin{matrix}E [ {\hat{P}}_{e}^{X} ] \approx {H}^{- 1} ( 1 - {μ}_{{\hat{I} ( H ; x )}_{2 {N}_{T}}} ) & ( 43 ) \\ {σ}_{{\hat{P}}_{{e}_{N}}^{x}}^{2} \approx \{ {f}^{′} ( {μ}_{{\hat{I} ( H ; x )}_{2 {N}_{T}}} ) \} 2 \cdot {σ}_{{\hat{I} ( H ; x )}_{N}}^{2} & ( 44 )\end{matrix}$$

The use of Eq. (44) requires an estimate of the mean of Î(H;\vec{X}), which is taken to be the sample mean μ_{Î(H;x)}_{_{N}}². The ultimate goal is to learn the sampling uncertainty for \hat{P}ₑ^{X},

$${σ}_{{\hat{P}}_{{e}_{N}}^{\vec{X}}} ,$$

from a low sample estimate of the mean of Î(H; \vec{X}),

$${μ}_{{\hat{I} ( H ; x )}_{2 {N}_{T}}} .$$

Manipulating Eq. (44) above, σ_{Î(H;x)}_{_{N}}² can be written in terms of the required variance on the estimate of error,

$${σ}_{{\hat{P}}_{{e}_{Req}}^{x}}^{2} :$$

$${σ}_{{\hat{I} ( H ; x )}_{N}}^{2} \leq {σ}_{{\hat{P}}_{{e}_{Req}}^{x}}^{2} \cdot {log ( \frac{{H}^{- 1} ( 1 - {μ}_{{\hat{I} ( H ; x )}_{2 {N}_{T}}} )}{1 - {H}^{- 1} ( 1 - {μ}_{{\hat{I} ( H ; x )}_{2 {N}_{T}}} )} )}^{2} \qquad ( 45 )$$

To ensure

$${σ}_{{\hat{P}}_{{e}_{N}}} \leq {σ}_{{\hat{P}}_{{e}_{Req}}} ,$$

the relationship in Eq. (45) is essential.

The regime of interest is where Î(H; \vec{X}) is close to 1 and

$${H}^{- 1} ( 1 - {μ}_{{\hat{I} ( H ; x )}_{2 {N}_{T}}} )$$

and thus \hat{P}ₑ^{X} is small. The derivative of the estimate in this regime is on the order of 0.25 as illustrated in FIG. 8. A slope of 0.25 is small relative to the range of values given in FIG. 8, yet large with respect to

$${μ}_{{\hat{I} ( H ; x )}_{2 {N}_{T}}} .$$

Therefore, errors in the estimate of μ_{Î(H,x)} can have a significant impact on the estimate of the number of samples required to reach a target sampling uncertainty of

$${σ}_{{\hat{P}}_{{e}_{Req}}^{x}}^{2} .$$

This means that a conservative approach is needed to estimate E[Î(H; \hat{X})] based on a small number of samples. Instead of using the sample mean

$${μ}_{{\hat{I} ( H ; x )}_{2 {N}_{T}}}$$

as an estimate of the expectation E{Î(H; \vec{X})}, a value somewhat less than the sample mean should be chosen.

Depending on the level of confidence required in the estimate of the number of samples N, a higher confidence estimate can be achieved by replacing

$${μ}_{{\hat{I} ( H ; x )}_{2 {N}_{T}}} with {μ}_{{\hat{I} ( H ; x )}_{2 {N}_{T}}} - {σ}_{{\hat{I} ( H ; x )}_{2 {N}_{T}}}$$

### in Eq. (45).

As discussed above, the variance on the estimate Î(H; \vec{X}),

$${σ}_{{\hat{I} ( H ; x )}_{2 {N}_{T}}}^{2} ,$$

can be scaled to large sample size

$$( {σ}_{{\hat{I} ( H ; x )}_{N}}^{2} ) .$$

The mean of the estimate of Î(H; \vec{X}),

$${μ}_{{\hat{I} ( H ; x )}_{2 {N}_{T}}} ,$$

and the standard deviation,

$${σ}_{{\hat{I} ( H ; x )}_{2 {N}_{T}}} ,$$

can be estimated using the low number of samples (N=2N_{T}).

Sampling Uncertainty versus Variability in Performance: The expression in Eq. (45) provides guidance on the level of sampling uncertainty associated with Î(H; \vec{X}) that is required to achieve the corresponding sampling uncertainty in \hat{P}ₑ^{X}. A more important question relevant to the study of uncertainty and performance estimation is the relationship introduced in Eq. (44) and written in general form:

$$\frac{{σ}_{{\hat{P}}_{{e}_{N}}^{\vec{X}}}^{2}}{{σ}_{{P}_{e}^{\vec{X}}}^{2}} < α \qquad ( 46 )$$

The variable α may be set to limit the degree of sampling uncertainty to be realized in the performance confidence analysis. Using Eq. (44), Eq. 34 and the fact that σ_{IL}_{_{\vec{X}}}²=σ_{I(H;\vec{X})}², Eq. (46) may be written as in Eq. (47):

$$\frac{{σ}_{{\hat{P}}_{{e}_{N}}^{\vec{X}}}^{2}}{{σ}_{{P}_{e}^{\vec{X}}}^{2}} \approx [ \frac{{σ}_{{\hat{I} ( H ; X )}_{2 \cdot {N}_{T}}}^{2}}{{σ}_{I ( H ; \vec{X} )}^{2}} ] . β ( N , {N}_{T} ) \qquad ( 47 )$$

The factor β(N,N_{T}) in Eq. (47) is given as:

$$β ( N , {N}_{T} ) = [ \frac{4 \cdot {N}_{T}^{2}}{{N}^{2}} ] \cdot [ \frac{log [ \frac{{H}^{- 1} ( 1 - {μ}_{I ( H ; \vec{X} )} )}{1 - {H}^{- 1} ( 1 - {μ}_{I ( H ; \vec{X} )} )} ]}{log [ \frac{{H}^{- 1} ( 1 - {μ}_{{\hat{I} ( H ; X )}_{2 \cdot {N}_{T}}} )}{1 - {H}^{- 1} ( 1 - {μ}_{{\hat{I} ( H ; X )}_{2 \cdot {N}_{T}}} )} ]} ] .$$

Thus, the expression in Eq. (48) may be used to test for conditions specified in Eq. (46):

$$[ \frac{{σ}_{{\hat{I} ( H ; X )}_{2 \cdot {N}_{T}}}^{2}}{{σ}_{I ( H ; \vec{X} )}^{2}} ] \cdot β ( N , {N}_{T} ) < α \qquad ( 48 )$$

The FBIT model provides a platform for the study and analysis of the relationship of the level of sampling uncertainty to the level of performance uncertainty. Incremental values for the ratio on the left side of Eq. (48) can be computed for increasing N. The point at which the inequality is obeyed is related to the phase transition minimum sample methods previously generated.

The following examples and methods are presented as illustrative of the present disclosure or methods of carrying out the invention, and are not restrictive or limiting of the scope of the invention in any manner.

An Information Flow Numerical Example: The application of the FBIT method to the study of uncertainty propagation is now illustrated within a simple radar sensor example. An information loss budget is constructed for a baseline design. Selected forms of uncertainty in Table 1 are introduced into the system to demonstrate the analysis of the effects of propagating uncertainty through the information sensing channel.

Observed Target Scattering Model: In the high frequency regime used to obtain HRR signatures, the target may be approximated as a collection of scattering centers valid over a limited aspect window and frequency band. These scattering centers may be considered to be localized to a point and may represent a variety of scattering phenomena ranging from specular reflection to diffraction phenomena such as edge and tip diffraction. The fields radiated by these point scatterers depend upon both temporal and spatial frequencies (angular dependence). Because the radar illuminating the target has finite bandwidth and is a one dimensional imaging system, the target is seen as a collection of contiguous swaths of range, with each range swath corresponding to a particular range. The extent of each range swath, range resolution, depends upon the signal bandwidth. For a typical extended target of interest, each range swath contains a number of scattering centers which can be widely spaced in cross-range.

The electromagnetic field obtained as a result of the interference of the scattered fields from the scattering centers appears as the signal corresponding to a particular range bin of the target signature. The target signature may be considered to be a one dimensional image of the reflectivity (or scattering) profile of the target for a given azimuth/elevation aspect angle (θ, ϕ) and bandwidth. The mathematical definition of the radar signature is developed from the normalized scattered field in Eq. (49), where \vec{E}^{s} and \vec{E}ⁱ are the scattered field and the incident field, respectively:

$$S ( θ , φ ) = {lim}_{R \to ∞} 4 π {R}^{2} \frac{{\vec{E}}^{S}}{\vert {\vec{E}}^{i} \vert} \qquad ( 49 )$$

Using scattering center modeling and the far field approximation, Eq. (49) can be written in terms of the target aspect angle and the transmitted wavelength as shown in Eq. (50):

$${S}_{E} ( θ , φ , λ ) {\sum }_{m = 1}^{M} \sqrt{{σ}_{m}} {e}^{j \frac{4 π}{λ} {R}_{m} ( θ , φ )} \qquad ( 50 )$$

In Eq. (50), S_{E} is the band-limited frequency response of the target comprised of M scattering centers at the respective range Rₘ. Conditioned on the target hypothesis H at a fixed aspect angle (θᵢ, ϕᵢ), \vec{S}_{E}(θᵢ, ϕᵢ)=S_{E}, (θᵢ, ϕᵢ, λ), λ∈ {λₗ, λₗ₊₁. . . λ_{f}} defines the band-limited frequency response of the normalized scattered field measurements given in Eq. (50). Clusters of simple scattering centers are chosen for targets of interest at X-band frequencies (8-12 GHz) in the following development. The targets are electrically large with dimensions in range and cross-range of many wavelengths. The target cluster of M isotropic scatters occupies the target volume within the radar sensor coordinate system illustrated in FIG. 10.

The three-dimensional target scattering center configuration for the two targets examined in the following example occupy an approximate cubic volume of {x=2, y=3, z=2.5} meters and are positioned at a line-of-site, \vec{l}os , of for (θₜ, ϕₜ)=10°,7.5°. Both targets are comprised of 100 scattering centers of unity amplitude and three strong localized scattering clusters of amplitude 5. Target 1 differs from target 2 in that the length of the target 1 is shorter than target 2 in the Y dimension by 0.5 meters. One of the localized scattering clusters is also displaced by (0.2, 0.2, 0) meters.

Radar Sensor Model: Applying matched filter processing and the discrete Fourier transform to the observed signature \vec{S}_{E} (θᵢ, ϕᵢ) in additive noise, the measured HRR signature can be modeled for a range of frequencies present in the transmitted waveform. The multidimensional encoded source \vec{X}_{E}ⁱ is defined here as the vector form of the time delay transformation of the band-limited frequency response \vec{S}_{E} (θᵢ, ϕᵢ). The measured random signature process \vec{X}ₙⁱ, is then defined as in equation Eq. (51) were \vec{n} is additive white noise:

\vec{X}ₙⁱ=\vec{X}_{E}ⁱ+\vec{n} (51)

The process \vec{X}ₙⁱis modeled at the output of a radar step frequency measurement sensor system for the specified target aspect angle (θᵢ, ϕᵢ). The additive noise process \vec{n} is modeled as the sum of thermal white noise and quantization noise components. The quantization error component is thought of as a random process uncorrelated with both the signal and the thermal noise. The complete radar step frequency measurement model system parameters are summarized in Table 3.

The sensing of \vec{X}ₙⁱ in a dynamic, real world environment is subject to the uncertainties listed in area 1 of Table 1 leading to the random signature process \vec{X} as previously outlined and as summarized in Table 2. Given the dynamic nature of the phenomenon underlying these uncertainties, the statistics associated with the dimensions of \vec{X} are often time varying. The target statistics are assumed to be stationary (constant with time), thus, the sample signatures associated with this random vector correspond to a stationary random process. Given the short measurement times associated with radar measurements of the nature under study, this assumption is appropriate.

TABLE 3
SENSOR SUMMARY

| | |
|---|---|
| Center frequency | 9.6 GHz |
| Transmit Bandwidth | 800 MHz |
| Number Bits in A/D | 8 Bits |
| Conversion | |
| Number of Pulses | 1024 |
| Integrated | |
| Signal-to-Noise Ratio | 20 dB |
| (time delay domain) | (variable) |

Modeling Pose Angle Estimation Uncertainty: The observed object aspect angle estimate can be viewed as lying within a solid cone angle centered on the observed object aspect angle (θₜ, ϕₜ). The parameter σₜ is defined as the uncertainty associated with the sensor estimate of (θₜ, ϕₜ). The parameter σₜ and μₜ are elements of \vec{V}ₜ and are the standard deviation and bias of the object aspect angle estimate, respectively.

The variation in measured signature phenomenology due to the uncertainties in target aspect angle are generated in the signal model in Eq. (50) through the introduction of distributions on θ and ϕ. The parameters θ and ϕ are both modeled as Gaussian random variables each with variance σₜ² and mean μₜ+θₜ, μₜ+ϕₜ. The bias parameter μₜ is assumed to be unknown and is modeled uniformly distributed between the interval [−1, 1] degrees.

Modeling Leading Edge Position Estimation Uncertainty: The leading edge location estimation will vary under real world sensing conditions. Thus, the range alignment (along \vec{l}os) of the measured signature process \vec{X} to the decision rule training process \vec{X}′, is imperfect and can be modeled as an uncertainty source. The process \vec{X} alignment to \vec{X} is modeled through a positive bias applied to the phase center of the scattering cluster underlying \vec{X}. The bias parameter μᵣ is assumed to be unknown and is modeled uniformly distributed between [0, 2] meters. Note that μᵣ is another element of \vec{V}ₜ.

Modeling Imperfect Training: The training process component \vec{X}′ in FIG. 2 represents the best achievable statistical characterization of the observed signature process \vec{X}. Signature training processes must represent the radar measured signature process across a wide range of measurement uncertainties and target configurations, as well as under many uncertain operating conditions including clutter, obscuration, and other sources of radio frequency (RF) interference. Construction of a signature training database derived entirely from measurements is expensive and can be an impractical proposition. It is possible to construct a signature database using electromagnetic scattering codes. However, given the complexity of typical targets and the challenge of modeling a variety of electromagnetic scattering phenomena ranging from specular reflection to edge diffraction, smooth surface diffraction, etc., computation of signatures with sufficient accuracy is a challenging task. Within this analysis, the dissimilarity between \vec{X} with \vec{x}′ will be generated using a matched scattering center model configuration with k . The uncertain parameters of \vec{V}ₜ and \vec{V}_{E} modeled within \vec{X} are not modeled in \vec{X}′. \vec{X}′=\vec{X} only when \vec{x} is used directly for the training of the decision rule d.

Feature Discriminate and Decision Rule Design: The function f used to compute the feature discriminate \vec{Y} in FIG. 2 is developed from the squared error of the distance from the mean templates \vec{μ}_{\vec{X}}_{₁} and \vec{μ}_{\vec{X}}_{₂} derived from the marginal training processes \vec{X}′₁ and \vec{X}′₂ as defined below. The operator |\vec{τ}| is defined as the element-wise magnitude of each complex element of the random vector \vec{τ}.

\vec{μ}_{\vec{X}}_{₁}′=E{|\vec{X}′₁|}, \vec{μ}_{\vec{X}′}_{₂}=E{|\vec{X}′₂|}, \vec{μ}_{\hat{X}}_{₁₂}′=\vec{μ}_{\vec{X}}_{₁}′−\vec{μ}_{\vec{X}′}_{₂}

\vec{Y}₁=[\vec{X}₁|−\vec{μ}_{\vec{X}}_{₁₂}′]·[\vec{X}₁|−\vec{μ}_{\vec{X}}_{₁₂}′]^{T}

\vec{Y}₂=[\vec{X}₂|−\vec{μ}\vec{X}₁₂′][\vec{X}₂|−\vec{μ}_{\vec{X}′}_{₁₂}]^{T}

\vec{Y}=[\vec{Y}₁, \vec{Y}₂]

The Maximum Likelihood estimator is used to determine the optimal decision rule d:

$$d = E \{ \frac{E \{ {\vec{Y}}_{1} \} - E \{ {\vec{Y}}_{2} \}}{2} \}$$

Assuming equally likely priors on each of the binary hypotheses H₁ and H₂ in \vec{X} and \vec{Y}, the samples (\vec{Y}) from \vec{Y} are applied to the decision ruled . \vec{Y}<d are declared from Hi (denoted Q₁) and \vec{Y}>d are declared from H₂ (denoted Q₂). The in-class and out-of-class scoring system is given by the conditional probabilities within α, β, γ, and κ as provided below:

α=p(\vec{X}₁)·p(Q₁/\vec{X}₁), β=p(\vec{X}₁)·p(Q₂/\vec{X}₁)

γ=p(\vec{X}₂)·p(Q₁/\vec{X}₂, ) κ=p(\vec{X}₂)·p(Q₂/\vec{X}₂)

The output of the decision algorithm Q as formed from the scoring system above can be summarized by the confusion matrix for the binary classifier given in Table 4:

TABLE 4
CONFUSION MATRIX FOR Q

Train Class

| Test Class | \vec{x}′₁ | \vec{x}′₂ |
|---|---|---|
| \vec{x}₁ | α | β |
| \vec{x}₂ | γ | κ |

Certainty States: The most certain state achievable for the example HRR radar example presented here is the case of the observed deterministic multivariate signal in noise (\vec{X}ₙⁱ) when accompanied by perfect training (\vec{X}′=\vec{X}ₙⁱ). Table 5 relates selected combinations of measurement and training uncertainty sources from Table 1. The cases 1-6 identified in Table 5 represent the certainty states of interest within the system. Unknown parameters are shown in bold.

TABLE 5
MEASUREMENT AND TRAINING CERTAINTY CASES

| Case | Training Level | Measurement Level |
|---|---|---|
| No. | \vec{X}′ = \vec{X}ₙ | \vec{X}ₙ |
| Case | σₜ = 0°, μₜ = 0° | σₜ = 0°, μₜ = 0° |
| 1 | σᵣ = 0 m, μᵣ = 0° SNR = 20 dB | σᵣ = 0 m, μᵣ = 0° SNR = 20 dB |
| | (θₜ, φₜ) = 10°, 7.5° | (θₜ, φₜ) = 10°, 7.5° |
| Case | σₜ = .75°, μₜ | σₜ = .75°, μₜ |
| 2 | σᵣ = 0 m, μᵣ = 0° SNR = 20 dB | σᵣ = 0 m, μᵣ = 0° SNR = 20 dB |
| | (θₜ, φₜ) = 10°, 7.5° | (θₜ, φₜ) = 10°, 7.5° |
| Case | σₜ = .75°, μₜ = 0° | σₜ = .75°, μₜ = 0° |
| 3 | σᵣ = 0 m, μᵣ SNR = 20 dB | σᵣ = 0 m, μᵣ SNR = 20 dB |
| | (θₜ, φₜ) = 10°, 7.5° | (θₜ, φₜ) = 10°, 7.5° |
| Case | σₜ = .75°, μₜ = 0° | σₜ = .75°, μₜ = 0° |
| 4 | σᵣ = 0 m, μᵣ = 0° SNR | σᵣ = 0 m, μᵣ = 0° SNR |
| | (θₜ, φₜ) = 10°, 7.5° | (θₜ, φₜ) = 10°, 7.5° |
| Case | σₜ = .75°, μₜ | σₜ = .75°, μₜ |
| 5 | σᵣ = 0 m, μᵣ SNR | σᵣ = 0 m, μᵣ SNR |
| | (θₜ, φₜ) = 10°, 7.5° | (θₜ, φₜ) = 10°, 7.5° |
| Case | σₜ = .75°, μₜ | σₜ = .75°, μₜ |
| 6 | σᵣ = 0 m, μᵣ = 0° SNR = 20 dB | σᵣ = 0 m, μᵣ SNR |
| | (θₜ, φₜ) = 10°, 7.5° | (θₜ, φₜ) = 10°, 7.5° |

* note: Parameter μₜ modeled uniform [−1°, 1°], Parameter μ, modeled uniform [0°, .2°], Parameter SNR modeled Gaussian (μ = 20 dB, σ² = 4 dB).

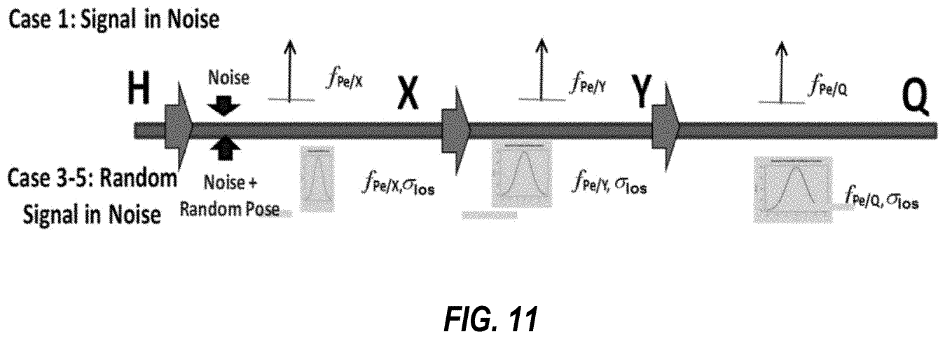

Assuming sufficient sampling to completely determine the probability density function (pdf) associated with the additive noise, the resulting statistical characteristics of the random performance functions will resemble the delta function and thus the reliability in predicted link performance (such as σₚ_{ₑ}) will be very high as shown in case 1 of Table 5. In a less certain case, the signal under measurement is random in nature (\vec{X}). The expected performance of the random performance functions will reflect the loss in information due to the degree of uncertainty present in \vec{X} as well as a decrease in reliability. Given the progressively large number of degrees of freedom associated with the uncertainty parameters associated with \vec{V}_{E} and \vec{V}ₜ in \vec{X}, the statistical support underlying the statistics of the random link performance functions Pₑ^{\vec{X}}, Pₑ^{\vec{Y}}, Pₑ^{Q}, and Pₑ^{Q}′ can quickly increase as is shown in case 3-5 in FIG. 11, which illustrates the propagation of uncertainty.

Case 1 of Table 5 represents an observed process \vec{X}ₙ of a stationary object of known aspect angle with perfect training. Case 1 conditions correspond to the highest certainty state possible. Case 2 corresponds to the observed process \vec{X} of an object that is moving slow enough as to appear stationary during the measurement interval. The aspect estimation is σₜ=0.75 degrees with an unknown bias (μₜ), and again the training is perfect. Case 3 conditions are similar with an unknown leading edge position bias μᵣ.

The signal-to-noise ratio (SNR) parameter is treated as an unknown parameter in Case 4. Case 5 is a combined condition of the unknown parameters in Cases 2, 3, and 4. In case 6, a form of imperfect training is presented where the measurement parameter uncertainty provided in Case 5 is combined with training level B (μᵣ=0 and μₜ=0).

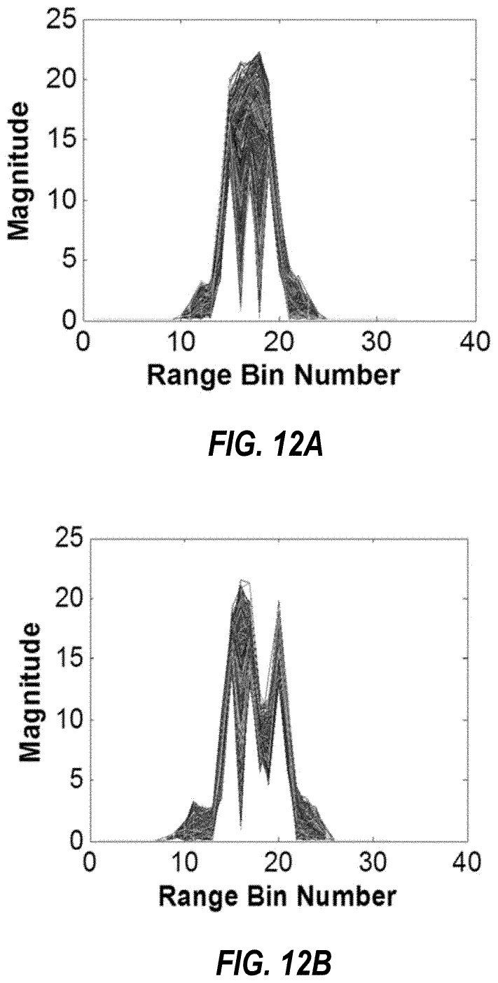

Sampling and FBIT Analysis: The amplitude response for the N sample ensemble of HRR signatures for a “baseline” set of conditions defined as Case 2 (μᵣ=0 and μₜ=0) are provided in FIGS. 12A and 12B (magnitude of \vec{X}₁ and \vec{X}₂, respectively). The five target features (K=5) at range bins 17-21 are selected for discriminate processing in \vec{X}→\vec{Y}.

Sampling Uncertainty Example: The sampling uncertainty previously defined is illustrated using the baseline uncertainty conditions and multiple target ensembles similar to those previously discussed. Using the Monte Carlo simulation, the typical set for \vec{X}₁, \vec{X}₂, and \vec{X}, is computed for an increasing value for N. Multiple ensembles of each are simulated at each value of N to generate both the mean and variance of the entropy estimate within the typical set.

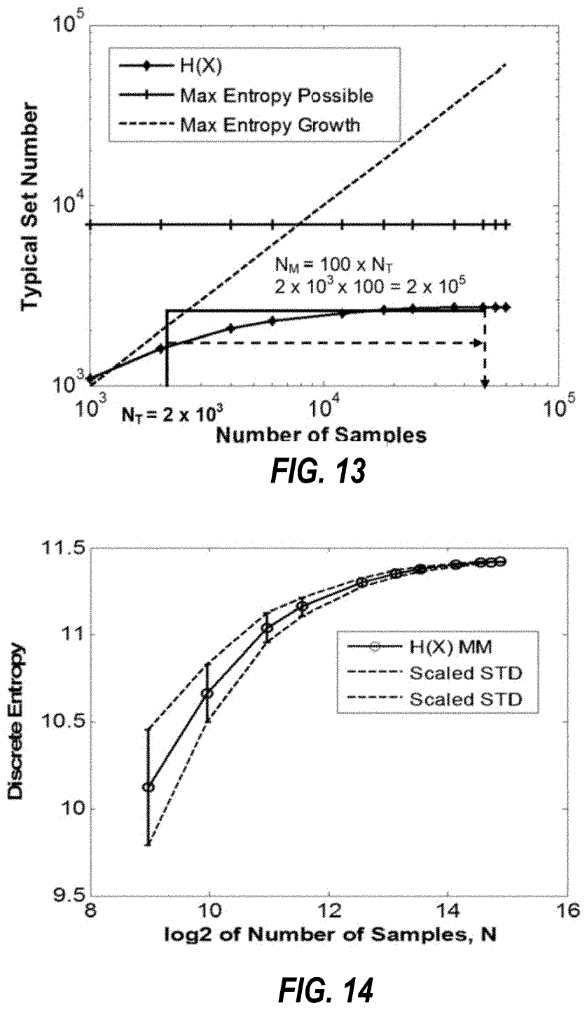

FIG. 13 illustrates the phase transition within a typical set of \vec{X}vs. N. The typical set plot in FIG. 13 provides the value for N_{M} for the entropy estimates for \vec{X} as defined previously where n_{b}=6. The number of samples required for each ensemble based on the phase transition at N_{T}=2×10³ within the typical set profile is N_{M}=2×10⁵.

FIG. 14 demonstrates the entropy scaling property previously discussed by illustrating the scaled standard deviation of estimator of entropy of \vec{X} vs. N. In the following example, Monte Carlo simulation is used to compute the actual estimation variance (L draws=1000; n_{b}=6) at each incremental setting of N_{M}. The estimation variance at N_{T}=3×10³ is scaled at each setting of N_{M} to N_{M}=2×10⁵, validating the use of the 1/N scaling factor in Eq. (47).

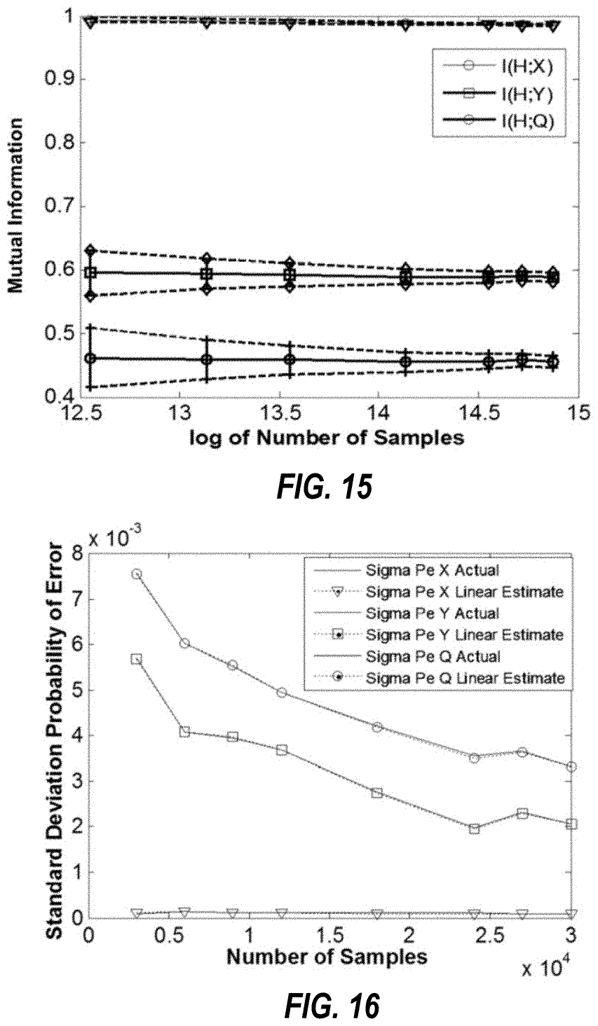

The sampling uncertainty associated with entropic estimation at \vec{X} is realized within the estimate Î(H; \vec{X}). FIG. 15 applies the 1/N scaling directly to the MLE estimate of Î(H; \vec{X}), Î(H; \vec{Y}), and Î(H; Q) beginning at 2×N_{T}=6×10³.

In Eq. (47), Corollary IV and V are used to compute the sampling uncertainty associated with the estimate of the probability of error. The following figures demonstrate the accuracy of Corollary IV and V using Eq. (44), which is applied at each link in the radar channel. Note that each application of Eq. (44) is conducted with the 2×N_{T}=6×10³ as the basis for the scaling. The approximation for the standard deviation of the probability of error is computed for the complete range of ensemble size out to N=3×10⁴. FIG. 16 provides a comparison of the probability of error estimate using Eq. (44) to the error computed using simulation where L=1000 and n_{b}=6. These results show that the estimates compare very nicely to the “actual” results. This agreement indicates that the dispersion of the mean mutual information of the estimate is low enough to support the use of the linear approximation.

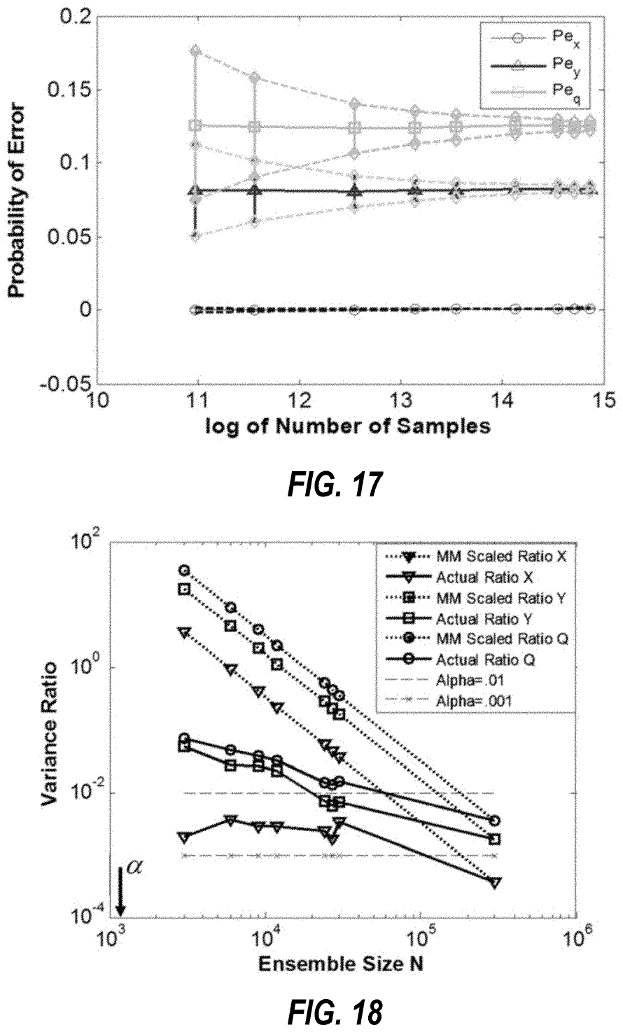

The application of Eq. (44) at each draw of the Monte Carlo simulation will generate an approximation of the sampling uncertainty within the probability of error estimate. FIG. 17 illustrates the application of Eq. (44) to the results in FIG. 15.

Eq. (48) provides the test for minimum sampling based on low sample ensemble sizes. In FIG. 18, Eq. (48) is applied to the radar example at the three link positions \vec{X}, \vec{Y} and Q. The test results in FIG. 18 show that the true ratio of sampling variance to the variability in predicted link performance is given as a function of ensemble size N. This is indicated by the solid lines. The dashed lines represent the ratio as given by the 1/N scaling as discussed above. The required ratio a is given by the dashed black line at two different levels. The results of the test given in Eq. (48) are given at each increment for N_{T}=3×10³. The interesting observation in FIG. 18 is that the point at which the test falls below the threshold α is consistent with the ensemble size N_{M} as derived from the phase transition point N_{T} as previously outlined. This is a significant validation of the phase transition method for estimating minimum ensemble size within Monte Carlo simulation. The results of the three tests above provide insight into the relationship of the required ensemble size N to the reliability in link performance estimates within sensitivity analysis simulations.

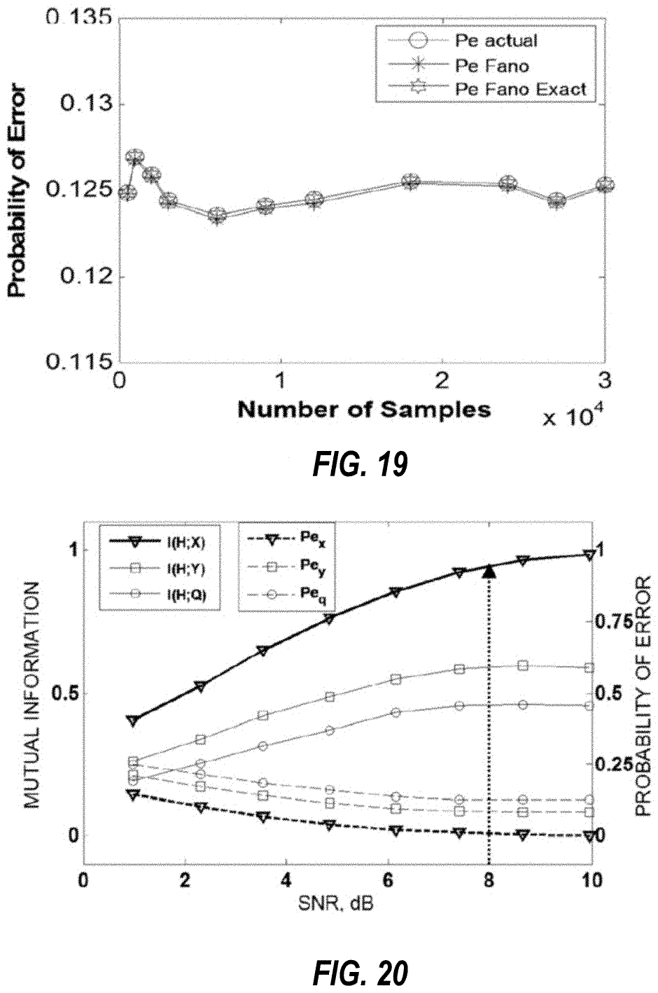

The Fano Equality: It is important to demonstrate the validity of Theorem I as written in Eq. (3). Using the radar example, FIG. 19 illustrates that the addition of I(Q;V) brings the approximation form of Fano into agreement with the “true” probability of error as simulated using Monte Carlo within the radar example outlined above. Again using Case 2 (μᵣ=0 and μₜ=0) conditions for the binary classification, the performance given by the Fano approximation is given by the line with asterisks (Pₑ Fano). The simulated “true” performance is given by the line with circles (Pₑ actual). The line with stars (Pₑ Fano Exact) represents the performance using the equality form of Fano in Theorem I. The equality form of Fano agrees with the “true” performance which validates Theorem I.

Experiments: The experiments conducted are given in Table 6:

TABLE 6
LIST OF EXPERIMENTS AND APPLICABLE CASES

| Experiment | Case | Hypothesis |
|---|---|---|
| 1. Information Flow | 2 | 1 |
| 2. System Trades | 2 | 2 |
| 3 System Uncertainty | 1, 2, 3, 4, 5, 6 | 3, 4, 5, |
| and Information Flow | | |

Information Flow and Design Trades within the Radar Channel: The value of the Data Processing Inequality is readily seen from FIGS. 20-22 where the individual loss at each link in the channel can be quantified. In each of the figures, the MI and probability of error is computed for a changing design parameter within v_{c}. Three design parameters are traded: system thermal noise, system dynamic range, and system bandwidth.

The signal-to-noise ratio of the signatures resulting from sensor measurements depends in part on the noise figure of the system. In FIG. 20, thermal noise is scaled by varying the noise figure across a range that affects a SNR range of 1 dB to 10 dB (SNR is given in frequency domain prior to inverse Fourier Transform gain). The results of the SNR trade indicate that an SNR of 8 dB in the frequency domain (19 dB in the time-delay domain after transform gain) will generate maximum information flow.

It is also of interest how the dynamic range of the sensor affects the information flow through the channel. Specifically, the sensitivity of I(H;Q) and ultimately Pₑ to the dynamic range in the sensor is of interest. The A/D conversion of the radar intermediate frequency (IF) signal to a digital representation must preserve the amplitude and phase information contained in the radar return with minimum error. The effects of quantization at each measurement point (quantization event) due to the twos-complement rounding error are assumed to be zero mean white noise processes. The A/D conversion and associated quantization noise are modeled as an additive noise component \vec{e} and added to the measured signature process.

\vec{X}ₙⁱ=\vec{X}_{E}ⁱ+\vec{n}+\vec{e} (52)

The maximum dynamic range supportable by a “B-bit” quantizer is the ratio of the largest representable magnitude to the smallest nonzero representable magnitude. The dynamic range for twos compliment and magnitude encoding for a “B-bit” quantizer is

$$Dynamic Range ( dB ) = 20 \cdot {log}_{10} ( \frac{{2}^{( B - 1 )} - 1}{1} ) .$$

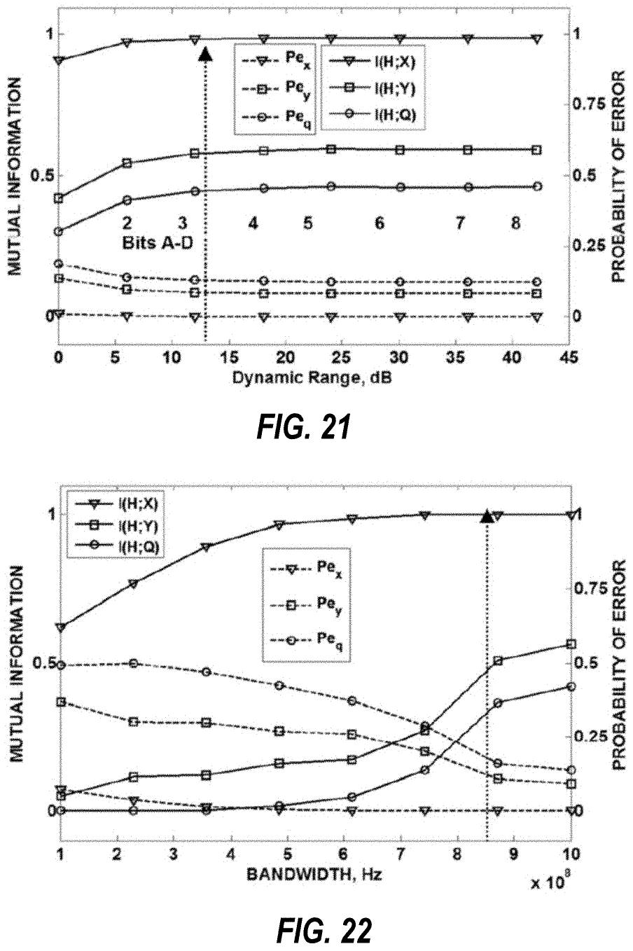

The dynamic range trade in FIG. 21 indicates that a 3 or 4 Bit A/D converter is needed to maximize information flow in the channel given the binary target set under evaluation.

The analysis of the bandwidth trade in FIG. 22 can be nicely linked to the physical scattering configurations of target 1 and target 2. As mentioned earlier port, the locations for the non-collocated dominant scatterer differ by 0.2 meters or 0.65 feet.

One would then expect that there should be a ‘bump’ in information flow when the bandwidth reaches levels that support the resolution necessary to resolve the peaks associated with these two scatterers. The theoretical resolution to achieve this feature separation would be approximately 800 MHz using the fundamental bandwidth relationship;

$$\frac{c \cdot τ}{2} = .6 feet = \frac{c}{2 \cdot BW} .$$

In FIG. 22, the bump in performance is centered at 800 MHz where the mutual information at \vec{Y} and Q is rapidly increasing and where the probability of error is greatly reduced.

In each figure, it can be seen that the MI decreases as links move further down the channel. With one Bit going into the channel (binary classification problem), Table 7 tabulates the information loss budget for each trade study at the selected baseline operating point.

The study of Table 7 reveals several key points. First, in this particular example problem, the targets appear to be separating very well at \vec{X}, and much of the loss occurs within the feature extraction and at the application of the decision rule. The loss at link \vec{Y} appears to be the dominant information limiting component in the system. There is a loss of 0.3-0.4 Bits at the feature extraction function at \vec{Y}. The information loss associated with signature measurement and signature processing results in only 0.1 Bits of loss. This is very important information in the effective optimization of system design for information sensing. Little gain can be expected through the expansion of sensing degrees of freedom (DOF) in improving the overall performance of the system.

TABLE 7
INFORMATION LOSS BUDGET FOR VARIOUS TRADES

| | Information Loss, Bits | | |
|---|---|---|---|
| | Trade 1 | | |
| System Component | (SNR) | Trade 2 (DR) | Trade 3 (BW) |
| Source-to-Measurement (\vec{X}) | 0.1 | 0.1 | 0.05 |
| Measurement-to-Feature (\vec{Y}) | 0.4 | 0.3 | 0.4 |
| Decision Rule Application (Q) | 0.1 | 0.2 | 0.1 |
| Total Channel Loss* | 0.6 | 0.6 | 0.55 |

*Baseline Conditions; SNR = 20 dB, BW = 800 MHz, DR = 20 dB

Also, the loss due to the decision component of the system is in the range of 0.1-0.2 Bits. Depending on the performance requirements of the system, improvements to the decision stage of the system may or may not be warranted. At the decision stage of the system, 0.4-0.5 bits of loss have been sustained resulting in an “upper bound” in performance of something in the area of Pₑ=0.1. No improvements to the classifier design within the decision component of the system can improve upon this performance level. Improvements appear to be best directed toward the feature extraction stage.

An optimal design operating point may for example include the following component selections: (i) A/D converter with B=4 Bits; (ii) receiver design that achieves 20 dB SNR under tactically significant conditions; and (iii) transmit waveform with BW >800 MHz.

Information Flow and System Uncertainty: The study of the effects of sources of uncertainty on system performance confidence while under control parameters [symbol] and in the presence of sensing uncertainty (\vec{V}_{E}, \vec{V}ₜ) is of particular interest. For a fully sampled signature process with negligible sampling uncertainty per Eq. (46), the FBIT method can be applied to study the independent sources of uncertainty. The effects of each independent source of uncertainty can be studied at each link in the channel. Eq. (36) is demonstrated for links \vec{X}, \vec{Y}, and Q under case 5 conditions defined in Table 5. Under these conditions, three independent sources of uncertainty are introduced in the system under perfect training conditions. An unknown bias in target aspect estimation and an unknown bias in leading edge range bias estimation are assumed. The target range is also unknown and as such a third uncertainty in introduced in the SNR of the measured signature. All assumed statistics associated with the uncertainties are as defined under case 5 of Table 5 and as described previously.

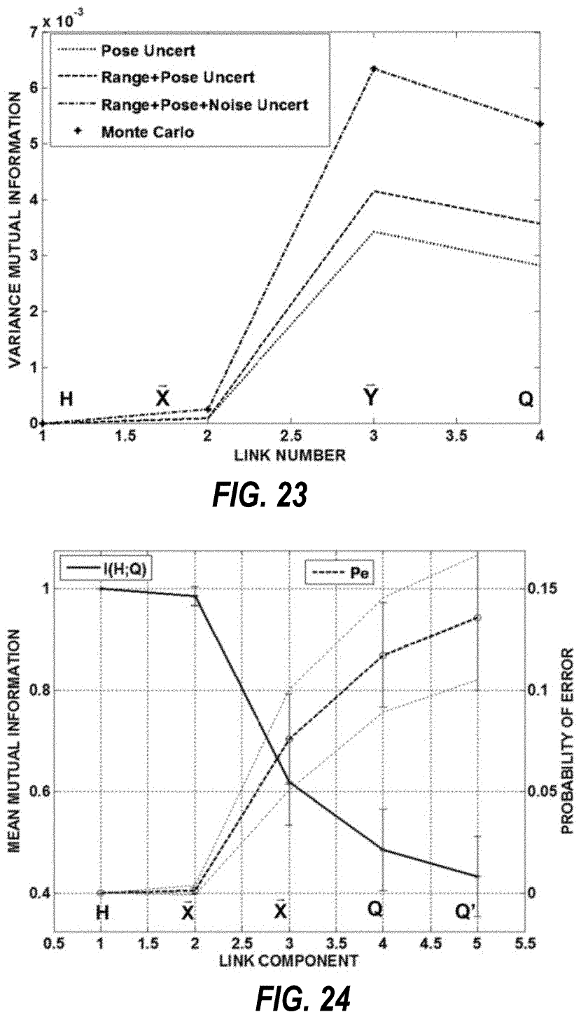

Using Monte Carlo simulation, L independent draws of an N_{M} sample ensemble from \vec{X} are generated. The FBIT method is applied at each draw to generate the decomposition of the performance estimate reliability in Eq. (36) at \vec{X}, \vec{Y}, and Q. In FIG. 23, the cumulative link loss standard deviation defined in Eqs. (24.a), (24.b), and (24.c) resulting from the sum of the independent three uncertainty sources is computed about the expected link information loss defined in Eqs. (23.a), (23.b), and (23.c). To clearly illustrate the level of agreement of the independent link loss contributions to the total produced by the joint simulation, the individual contributions to the cumulative link loss variance are individually plotted in an incremental fashion in FIG. 23. FIG. 23 shows that the sum of the independent uncertainty sources yields the same results as the Monte Carlo simulation involving all three factors in a joint process.

The corresponding impacts to the reliability in link performance can be generated through the application of Corollary IV and V. In FIG. 24, the reliability in predicted link performance as quantified by Definition 5 resulting from the sum of the independent three uncertainty sources is presented in the error bars about the expected link performance defined in Eqs. (31.a), (31.b), and (31.c). The dashed line represents the results of the joint Monte Carlo simulation where all three independent uncertainty factors are simulated simultaneously. The results in FIG. 24 show clearly that the sum of the independent events equals the joint event, thus validating the assumption of independence in the three sources of uncertainty acting on the predicted performance risk.

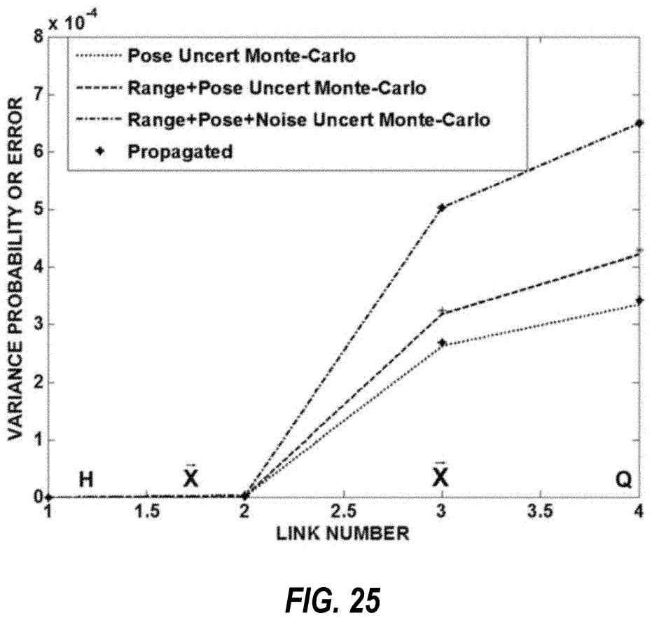

In FIG. 25, a similar validation of the propagation of independent uncertainty sources is given for the reliability in predicted performance. The example demonstrates that the use of Corollary IV and V to approximate the reliability on the performance estimate using the link loss variance is a very effective means to address the transcendental relationship underlying this method. The data points marked with the asterisks represent the sum of the independent contributions to the reliability in performance prediction. The respective plotted lines represent the results of direct simulation at the specified link.

The implications of imperfect training are realized in the final stage of the channel at Q′ as shown in FIG. 24. At Q′, case 6 conditions in Table 5 are used to present a naive training approach as previously developed.

A summary of the expected link loss, expected link performance, reliability in link performance, and results of respective sampling uncertainty tests in FIG. 18 are given in Table 8. The reliability in predicted performance decreases as information propagates down the sensing channel. The expected link performance also decreases in accordance with the principles of mutual information and the Data Processing Inequality. Much of the decrease in reliability and loss in predicted performance and loss in performance comes at the feature extraction stage in the system. The reduced reliability in performance prediction is most sensitive to the uncertainty factor of SNR. The effects of the factors associated with target range bias and pose estimate bias are of less significance relative to the total reliability in predicted performance.

TABLE 8
INFORMATION CONFIDENCE & LOSS BUDGET
FOR VARIOUS CONDITIONS
Link Information Measure

| | | Expected | Reliability | Sampling |
|---|---|---|---|---|
| | Link Loss, | Link | in Link | Uncertainty |
| Link | Bits | Performance | Performance | Test |
| H | 0.0 | — | — | — |
| \vec{X} | μ_{IL}_{_{SΔ}} = 0.05 | ${μ}_{{P}_{{e}_{{X}^{}}}} = 0.013$ | ${σ}_{{P}_{e}^{{X}^{}}} = 0.003$ | $( \frac{{σ}_{{\hat{P}}_{{e}_{N}}^{{X}^{}}}^{2}}{{σ}_{{P}_{{e}_{N}}^{{X}^{}}}^{2}} ) < .001$ |
| \vec{Y} | μ_{IL}_{_{FΔ}} = 0.35 | ${μ}_{{P}_{{e}_{{Y}^{}}}} = 0.073$ | ${σ}_{{P}_{e}^{{Y}^{}}} = 0.0228$ | $( \frac{{σ}_{{\hat{P}}_{{e}_{N}}^{{Y}^{}}}^{2}}{{σ}_{{P}_{{e}_{N}}^{{Y}^{}}}^{2}} ) < .003$ |
| Q | μ_{IL}_{_{DΔ}} = 0.16 | ${μ}_{{P}_{{e}_{Q}}} = 0.12$ | ${σ}_{{P}_{e}^{Q}} = 0.0255$ | $( \frac{{σ}_{{\hat{P}}_{{e}_{N}}^{Q}}^{2}}{{σ}_{{P}_{{e}_{N}}^{Q}}^{2}} ) < .006$ |
| Q′ | μ_{IL}_{_{TΔ}} = 0.04 | ${μ}_{{P}_{{e}_{{Q}^{′}}}} = 0.125$ | ${σ}_{{P}_{e}^{{Q}^{′}}} = 0.0266$ | — |

From Table 8 it can be seen that gains in performance due to component design trades must also take into account the reliability level associated with predicted performance. In this example problem, changes within two significant digits of the expected performance should be studied in the context of the reliability of the performance estimates based on uncertainty factors introduced in the system.

By virtue of the foregoing, a method is provided for identifying and characterizing component-level information loss in a nonlinear system comprising a plurality of components, wherein at least one of the components of the nonlinear system is subject to at least one source of uncertainty, each source of uncertainty comprising a plurality of system uncertainty parameters, the method comprising the steps of: (a) determining discrete decision states for the nonlinear system, wherein the discrete decisions states comprise a true object state H and a decision state Q, the discrete decision states being characterized in a Markovian channel model comprising a plurality of links, wherein each link corresponds to one component of the nonlinear system; (b) modeling the system uncertainty parameters to create a plurality of distributions, wherein each distribution comprises a plurality of values ranging from a theoretical maximum entropy to a theoretical minimum entropy for one system uncertainty parameter, wherein at least one of the system uncertainty parameters is unknown; (c) calculating an entropy at each component, H(H), H(X), H(Y), . . . H(Q), wherein the entropy is directly related to an amount of uncertainty at each component; (d) computing an amount of mutual information between H and Q, I(H;Q),wherein I(H;Q) is used to characterize a total system performance and wherein the at least one source of uncertainty increases a total amount of entropy in the nonlinear system, thereby decreasing I(H;Q) and degrading the total system performance; (e) calculating an amount of cumulative component information loss from H to Q, IL_{X}, IL_{Y}, . . . IL_{Q}, wherein IL_{Q} is equal to a sum of the component-level information loss that occurs at each component, IL_{XΔ}, IL_{YΔ}, . . . IL_{QΔ}, and wherein component-level information loss occurs only within the Markovian channel model; (f) correlating, using Fano's equality, at least one of I(H;Q) and IL_{Q} to the total amount of entropy to generate at least one overall probability of error Pₑ for the nonlinear system; (g) estimating, using the Data Processing Inequality together with Fano's equality, a component-level probability of error, Pₑ^{X}, Pₑ^{Y}, . . . Pₑ^{Q}; and (h) correlating the component-level probability of error to the component-level information loss.

In one or more embodiments, the method further comprises computing a component-level performance reliability and attributing a contribution of each system uncertainty parameter to the component-level performance reliability, the method comprising the steps of: (a) determining a real world statistical variation of the system uncertainty parameters; (b) performing a Monte-Carlo simulation of a plurality of the statistical uncertainty parameters for a plurality of settings through iteration of steps 1b) to 1h); (c) calculating a component-level probability of error statistical distribution at each component; (d) determining the component-level performance reliability based on a standard deviation of each component-level probability of error statistical distribution; and (e) correlating the contribution of each system uncertainty parameter to the component-level performance reliability.

In an exemplary embodiment, the step of performing the Monte-Carlo simulation further comprises determining a proper ensemble sample size. In an exemplary embodiment, the method further comprising determining at least one component-level ensemble sampling requirement for the method of claim 1, the method comprising the steps of: (a) determining a set of test criteria for a maximum allowable sampling uncertainty of the component-level information loss relative to the component-level probability of error statistical distributions; (b) determining a sample ensemble size N_{M} for the component-level information loss using a phase transition method; and (c) computing the component-level performance reliability using a numerical simulation method on the sample ensemble size N_{M}. In a particular embodiment, the numerical simulation method comprises Monte Carlo modeling.

In another aspect of the present disclosure, a method is provided for determining an optimal component design for a nonlinear system comprising a plurality of components, wherein at least one of the components of the nonlinear system is subject to at least one source of uncertainty, each source of uncertainty comprising a plurality of system uncertainty parameters, the method comprising the steps of: (a) establishing an information loss budget comprising a desired Pₑ^{Q}; (b) calculating component-level information loss, IL_{XΔ}, IL_{YΔ}, . . . IL_{QΔ}, according to claim 1; (c) calculating component probability of error, Pₑ^{X}, Pₑ^{Y}, . . . Pₑ^{Q}, according to claim 1 to generate a calculated Pₑ^{Q}; (d) comparing the calculated Pₑ^{Q} with the desired Pₑ^{Q}; (e) identifying at least one source of information reduction, wherein the at least one source of information reduction comprises at least one of component-level information loss and information flow reduction; (f) determining the optimal component design to minimize the calculated Pₑ^{Q}, wherein the optimal component design includes at least one tradeoff between information flow and component design, wherein the at least one tradeoff decreases the at least one source of information reduction; and (g) repeating steps 6b) to 6g) until the calculated Pₑ^{Q} is equal to or less than the desired Pₑ^{Q}.

In one or more embodiments, the method further comprising identifying at least two sources of information reduction, wherein the at least two sources of information reduction comprise at least one of component-level information loss and information flow reduction; ranking the at least two sources of information reduction according to impact on the calculated Pₑ^{Q}, wherein at least one dominant source of information reduction is identified; and determining the optimal component design to minimize the calculated Pₑ^{Q}, wherein the optimal component design includes at least one tradeoff between information flow and component design, wherein the at least one tradeoff decreases the at least one dominant source of information reduction.

Although specific embodiments have been described in detail in the foregoing description and illustrated in the drawings, various other embodiments, changes, and modifications to the disclosed embodiment(s) will become apparent to those skilled in the art. All such other embodiments, changes, and modifications are intended to come within the spirit and scope of the appended claims.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

In the preceding detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

Appendices A-C attached hereto are incorporated by reference in their entirety to the present application.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A method for identifying and characterizing component-level information loss in a nonlinear system comprising a plurality of components, wherein at least one of the components of the nonlinear system is subject to at least one source of uncertainty, each source of uncertainty comprising a plurality of system uncertainty parameters, the method comprising the steps of:
a) determining discrete decision states for the nonlinear system, wherein the discrete decisions states comprise a true object state H and a decision state Q, the discrete decision states being characterized in a Markovian channel model comprising a plurality of links, wherein each link corresponds to one component of the nonlinear system;
b) modeling the system uncertainty parameters to create a plurality of distributions, wherein each distribution comprises a plurality of values ranging from a theoretical maximum entropy to a theoretical minimum entropy for one system uncertainty parameter, wherein at least one of the system uncertainty parameters is unknown;
c) calculating an entropy at each component, H(H), H(X), H(Y), . . . H(Q), wherein the entropy is directly related to an amount of uncertainty at each component;
d) computing an amount of mutual information between H and Q, I(H;Q),wherein I(H;Q) is used to characterize a total system performance and wherein the at least one source of uncertainty increases a total amount of entropy in the nonlinear system, thereby decreasing I(H;Q) and degrading the total system performance;
e) calculating an amount of cumulative component information loss from H to Q, IL_{X}, IL_{Y}, . . . IL_{Q}, wherein IL_{Q} is equal to a sum of the component-level information loss that occurs at each component, IL_{XΔ}, IL_{YΔ}, . . . IL_{QΔ}, and wherein component-level information loss occurs only within the Markovian channel model;
f) correlating, using Fano's equality, at least one of I(H;Q) and IL_{Q} to the total amount of entropy to generate at least one overall probability of error Pₑ for the nonlinear system;
g) estimating, using the Data Processing Inequality together with Fano's equality, a component-level probability of error, Pₑ^{X}, Pₑ^{Y}, . . . Pₑ^{Q}; and
h) correlating the component-level probability of error to the component-level information loss.

2. The method of claim 1 further comprising computing a component-level performance reliability and attributing a contribution of each system uncertainty parameter to the component-level performance reliability, the method comprising the steps of:
a) determining a real world statistical variation of the system uncertainty parameters;
b) performing a Monte-Carlo simulation of a plurality of the statistical uncertainty parameters for a plurality of settings through iteration of steps 1b) to 1h);
c) calculating a component-level probability of error statistical distribution at each component;
d) determining the component-level performance reliability based on a standard deviation of each component-level probability of error statistical distribution; and
e) correlating the contribution of each system uncertainty parameter to the component-level performance reliability.

3. The method of claim 2 wherein the step of performing the Monte-Carlo simulation further comprises determining a proper ensemble sample size.

4. The method of claim 2 further comprising determining at least one component-level ensemble sampling requirement for the method of claim 1, the method comprising the steps of:
a) determining a set of test criteria for a maximum allowable sampling uncertainty of the component-level information loss relative to the component-level probability of error statistical distributions;
b) determining a sample ensemble size N_{M} for the component-level information loss using a phase transition method; and
c) computing the component-level performance reliability using a numerical simulation method on the sample ensemble size N_{M}.

5. The method of claim 4 wherein the numerical simulation method comprises Monte Carlo modeling.

6. A method for determining an optimal component design for a nonlinear system comprising a plurality of components, wherein at least one of the components of the nonlinear system is subject to at least one source of uncertainty, each source of uncertainty comprising a plurality of system uncertainty parameters, the method comprising the steps of:
a) establishing an information loss budget comprising a desired Pₑ^{Q};
b) calculating component-level information loss, IL_{XΔ}, IL_{YΔ}, . . . IL_{QΔ}, according to claim 1;
c) calculating component probability of error, Pₑ^{X}, Pₑ^{Y}, . . . Pₑ^{Q}, according to claim 1 to generate a calculated Pₑ^{Q};
d) comparing the calculated Pₑ^{Q} with the desired Pₑ^{Q};
e) identifying at least one source of information reduction, wherein the at least one source of information reduction comprises at least one of component-level information loss and information flow reduction;
f) determining the optimal component design to minimize the calculated Pₑ^{Q}, wherein the optimal component design includes at least one tradeoff between information flow and component design, wherein the at least one tradeoff decreases the at least one source of information reduction; and
g) repeating steps 6b) to 6g) until the calculated Pₑ^{Q} is equal to or less than the desired Pₑ^{Q}.

7. The method of claim 6 further comprising identifying at least two sources of information reduction, wherein the at least two sources of information reduction comprise at least one of component-level information loss and information flow reduction; ranking the at least two sources of information reduction according to impact on the calculated Pₑ^{Q}, wherein at least one dominant source of information reduction is identified; and determining the optimal component design to minimize the calculated Pₑ^{Q}, wherein the optimal component design includes at least one tradeoff between information flow and component design, wherein the at least one tradeoff decreases the at least one dominant source of information reduction.
